(19) United States
(12) Patent Application Publication
(10) Pub. No.: US 2005/0145731 A1
(43) Pub. Date: Jul. 7, 2005

(54) Scrapping method of building and scrapping machine

(76) Inventor: Toshihito Okamoto, Chosei-gun (JP)

Correspondence Address: JORDAN AND HAMBURG LLP, 122 EAST 42ND STREET, SUITE 4000, NEW YORK, NY, 10168, US

(21) Appl. No.: 11/048,551

(22) Filed: Jan. 31, 2005

Related U.S. Application Data
(63) Continuation of application No. 10/423,698, filed on Apr. 25, 2003.

(51) Int. Cl. B23H 1/00

(52) U.S. Cl. 241/101.72

(57) ABSTRACT

A scrapping method of constructions includes steps of moving a scrapping machine, locating the scrapping machine by self-run into the building, the scrapping machine capable of attaching one of a breaker and a clasped crushing device to a tip portion of a drive arm; forming a movement hole which is formed at a floor part of an upper floor by the scrapping machine after the movement process, the scrapping machine capable of passing through the movement hole and moving to the upper floor, moving the scrapping machine to the upper floor via the movement hole; moving the scrapping machine to the highest floor after the hole formation process and the movement process to the upper floor are performed one by one; scrapping at a top part of the building without the floor part located the scrapping machine, the building scrapping so as to place a demolition waste inside the building; discharging the demolition waste that produces at the scrapping process through the movement hole to the lower direction; and performing the demolition work to the lower floor after the scrapping machine moves to the lower floor after scrapping at a top part of the building, and the scrapping process for the top part of the building and discharging process are performed one by one so that it can scrap using the scrapping machine of a building it does not matter of the height of the building and can operate so as to place demolition waste inside the building from a top of the building and to transport the scraping machine to upper story easily, and the building is disassembled without securing the installation space or work space of the machine around the building.

### BACKGROUND OF THE INVENTION

This invention relates to the scrapping method of constructions such as a building and a scrapping machine. When the constructions such as buildings are scrapped conventionally, the breaker and clasped crushing device are attached in the tip part of the drive arm of the backhoe, and the building is disassembled from the outside the building.

In the conventional scrapping method using the backhoe, the building can be disassembled only range that the tip part of the drive arm of the backhoe reaches, and the disassembled part is restricted.

Moreover, the breaker and clasped crushing device attached in the tip part of the drive arm can move only around the backhoe and to an outer direction.

Furthermore, installation of the backhoe and reservation of work space are needed for the outside of the building in order to disassemble a building from the outside of the building so that some troubles are happened and the operation troubles the neighbors.

### SUMMARY OF HE INVENTION

Accordingly, it is an object of the invention to provide a scrapping method of constructions which can scrap using the scrapping machine of a building it does not matter of the height of the building.

It is another object of the invention to provide a scrapping method of constructions which can operate so as to place the demolition waste inside the building from a top of the building and to transport the scraping machine to upper story easily, and the building is disassembled without securing the installation space or work space of the machine surround the building.

It is further object of the invention to provide a scrapping machine which can fully be done even if it has the small drive arm and body as a mini backhoe.

Novel features which are believed to be characteristic of the invention, both as to its organization and method of operation, together with further objects and advantages thereof, are described below with reference to the accompanying drawings in which preferred embodiments of the invention are illustrated as an example.

It is to be expressly understood, however, that the drawings are for the purpose of illustration and description only, and are not intended as a definition of the limits of the invention.

### BRIEF DESCRIPTION OF THE DRAWINGS

FIG. 1 is a flow showing a first embodiment of the present invention;

FIG. 2 is an explanatory view for moving a scrapping machine;

FIG. 3 is a side view of a scrapping machine;

FIG. 4 is a front view of a scrapping machine;

FIG. 5 is a top view of a scrapping machine;

FIG. 6 is a side view showing the way in which the clasped crushing device is attached;

FIG. 7 is an explanatory view showing the way in which a hole for moving is formed;

FIG. 8 is an explanatory view showing the way in which the scrapping machine moves to an upper floor;

FIG. 9 is an explanatory view showing the way in which the scrapping machine moves to a top floor;

FIG. 10 is an explanatory view showing the way in which the upper part of the building is scraped;

FIG. 11 is a flow showing a second embodiment of the present invention;

FIG. 12 is an explanatory view for moving a scrapping machine;

FIG. 13 is an explanatory view showing the way in which the demolition waste is discharged;

FIG. 14 is a flow showing a third embodiment of the present invention;

FIG. 15 is an explanatory view showing the way in which the scrapping machine moves to a top floor;

FIG. 16 is an explanatory view showing the way in which the demolition work is operated;

FIG. 17 is a flow showing a fourth embodiment of the present invention;

FIG. 18 is an explanatory view for moving a scrapping machine;

FIG. 19 is a top view of a scrapping machine;

FIG. 20 is a side view of a scrapping machine showing a fifth embodiment of the present invention;

FIG. 21 is a top view of a scrapping machine;

FIG. 22 is an explanatory view for moving a scrapping machine;

FIG. 23 is a side view of a scrapping machine showing a sixth embodiment of the present invention;

FIG. 24 is a top view of a scrapping machine;

FIG. 25 is an explanatory view of a mount;

FIG. 26 is a flow showing a seventh embodiment of the present invention;

FIG. 27 is an explanatory view showing the way in which the scrapping machine moves to an upper floor;

FIG. 28 is a top view of a scrapping machine;

FIG. 29 is a flow showing an eighth embodiment of the present invention;

FIG. 30 is an explanatory view showing the way in which the scrapping machine moves to an upper floor;

FIG. 31 is a top view of a scrapping machine;

FIG. 32 is a flow showing a ninth embodiment of the present invention;

FIG. 33 is an explanatory view showing the way in which the scrapping machine moves to an upper floor;

FIG. 34 is a side view of a scrapping machine;

FIG. 35 is a side view showing a tenth embodiment of the present invention;

FIG. 36 is a top view;

FIG. 37 is a front view;

FIG. 38 is an explanatory view showing the way in which extensible legs are stored;

FIG. 39 is an explanatory view showing the way in which the scrapping machine moves to an upper floor;

FIG. 40 is a side view showing an eleventh embodiment of the present invention;

FIG. 41 is a top view;

FIG. 42 is a front view;

FIG. 43 is a side view showing a twelfth embodiment of the present invention;

FIG. 44 is a top view;

FIG. 45 is a front view;

FIG. 46 is a side view showing a thirteenth embodiment of the present invention;

FIG. 47 is a top view;

FIG. 48 is a front view;

FIG. 49 is a side view showing a fourteenth embodiment of the present invention;

FIG. 50 is a top view;

FIG. 51 is an explanatory view showing the way in which the scrapping machine moves to an upper floor;

FIG. 52 is a side view showing a fifteenth embodiment of the present invention;

FIG. 53 is a top view;

FIG. 54 is an explanatory view showing the way in which the scrapping machine moves to an upper floor;

FIG. 55 is a side view showing a sixteenth embodiment of the present invention;

FIG. 56 is a top view;

FIG. 57 is a front view;

FIG. 58 is an explanatory view of a drive arm;

FIG. 59 is an explanatory view of a movement mechanism to forward-, backward-, left- and right directions;

FIG. 60 is a side view of an attachment for a crushing machine;

FIG. 61 is a top view of an attachment for a crushing machine;

FIG. 62 is an explanatory view showing the way in which a breaker is used;

FIG. 63 is an explanatory view showing the way in which a clasped crushing device is used;

FIG. 64 is an explanatory view showing the way in which extensible legs are extended;

FIG. 65 is an explanatory view showing the way in which a scrapping machine moves to an upper floor;

FIG. 66 is an explanatory view showing the way in which a scrapping machine moves through a hole;

FIG. 67 is a side view showing a seventeenth embodiment of the present invention;

FIG. 68 is a top view;

FIG. 69 is a front view;

FIG. 70 is an explanatory view showing the way in which a scrapping machine is hanged up into an elevator hole;

FIG. 71 is an explanatory view of an extensible base;

FIG. 72 is an explanatory view showing the way in which an extensible base is operated;

FIG. 73 is another side view;

FIG. 74 is a side view showing an eighteenth embodiment of the present invention;

FIG. 75 is a top view;

FIG. 76 is a front view;

FIG. 77 is a side view showing a nineteenth embodiment of the present invention;

FIG. 78 is a top view;

FIG. 79 is a front view;

FIG. 80 is a side view showing a twentieth embodiment of the present invention;

FIG. 81 is a top view;

FIG. 82 is a front view;

FIG. 83 is an explanatory view of a movement device for caterpillar;

FIG. 84 is an explanatory view showing the way in which a movement device for caterpillar works; and

FIG. 85 is another top view.

### DETAILED DESCRIPTION OF THE PREFERRED EMBODIMENTS

Preferred embodiments of the present invention are described in more detail below with reference to the accompanying drawings.

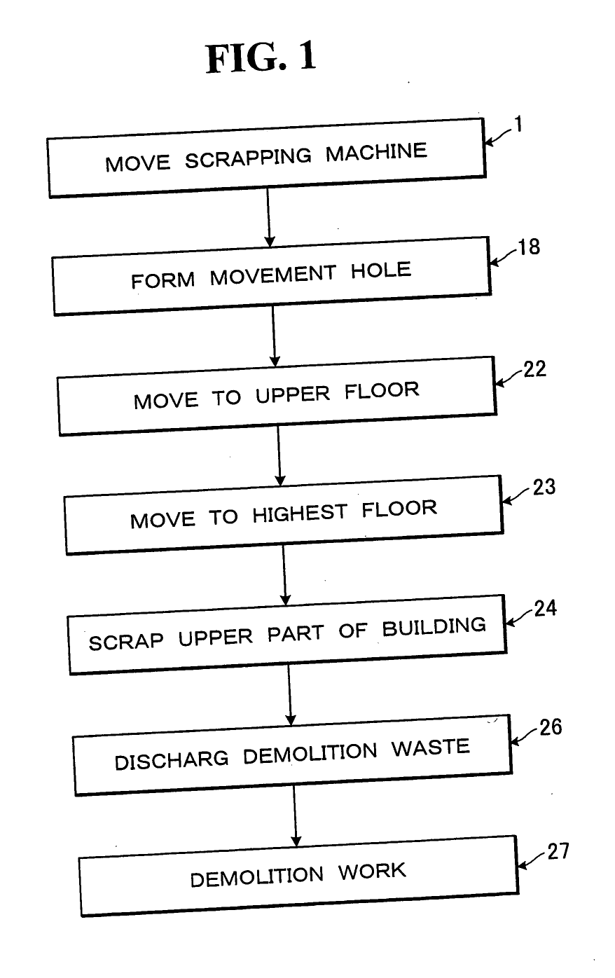

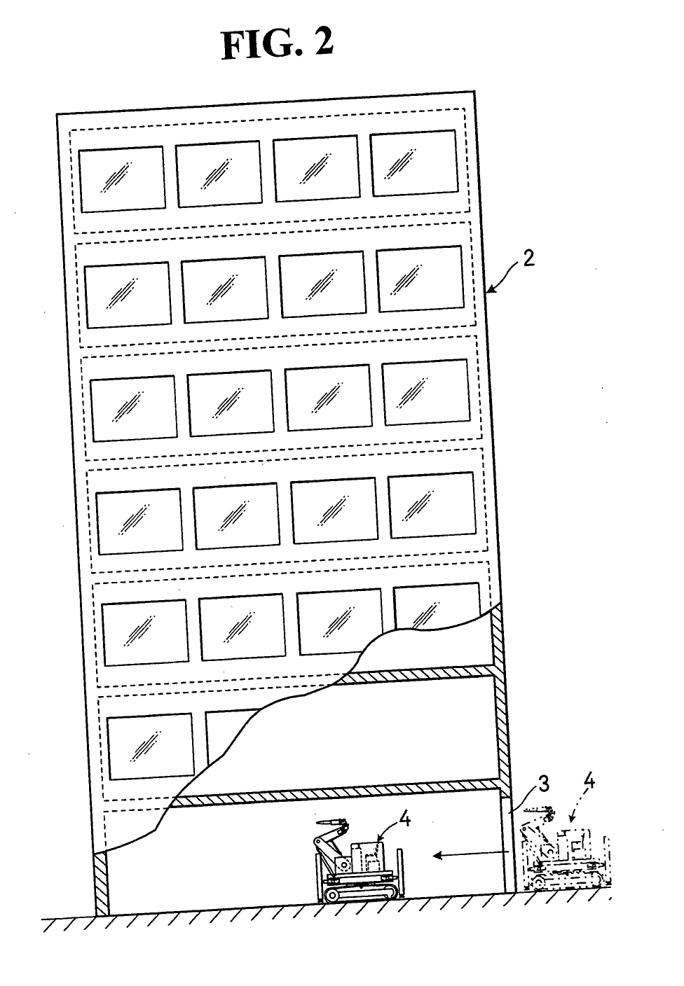

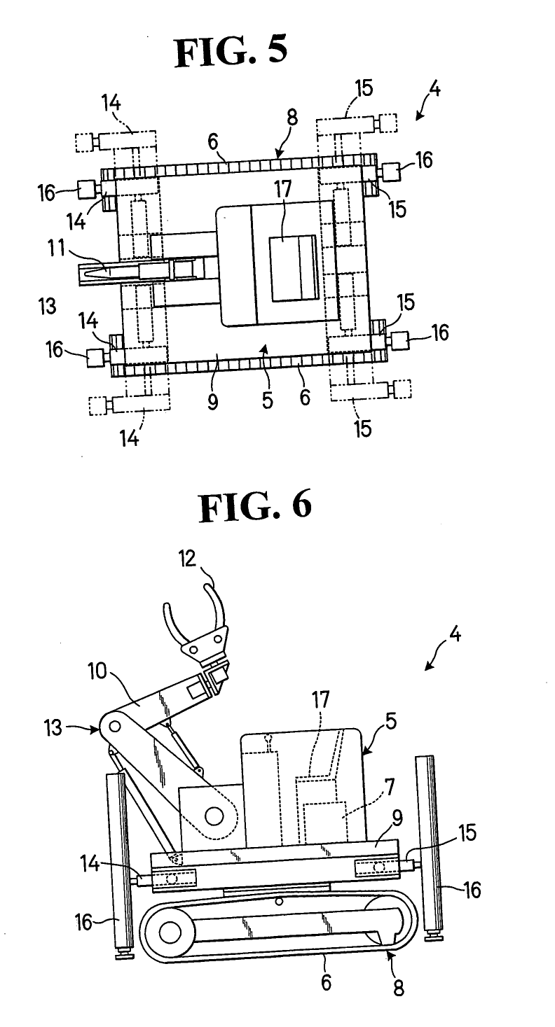

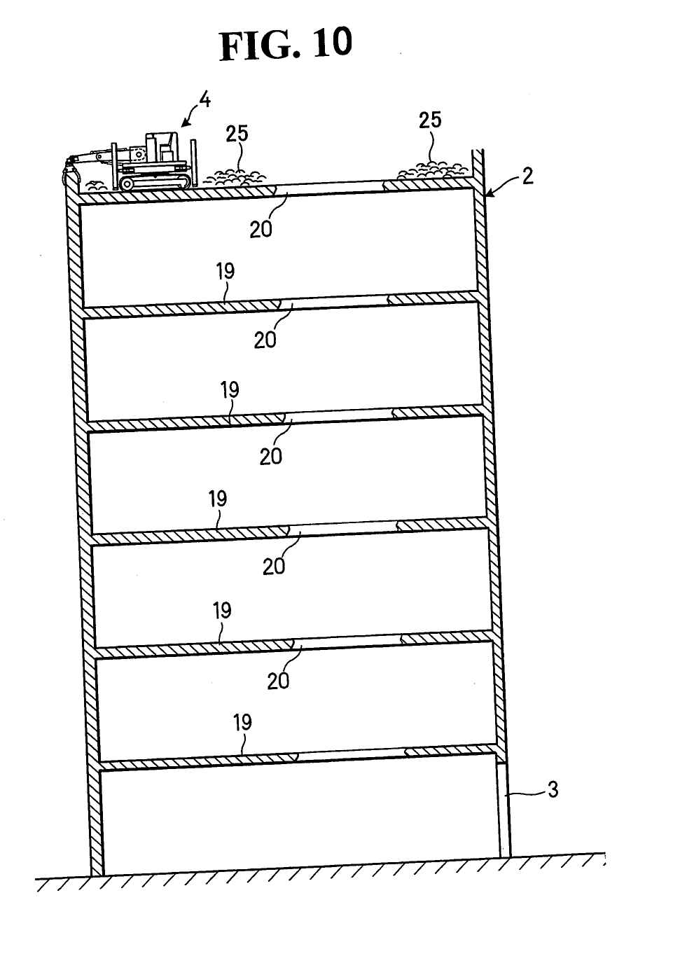

An understanding of the present invention may be best gained by reference to FIGS. 1-10. FIGS. 1-10 illustrate a scrapping method of constructions such as a building in accordance with a first embodiment of the present invention.

The numeral 1 shows a step for moving of a scrapping machine 4 of a building 2, and the scrapping machine 4 is located by self-run inside from an opening 3 of the building 2 disassembled from an outside. The scrapping machine 4 of the building used at the movement process 1 is formed in substantially the same size as a mini backhoe.

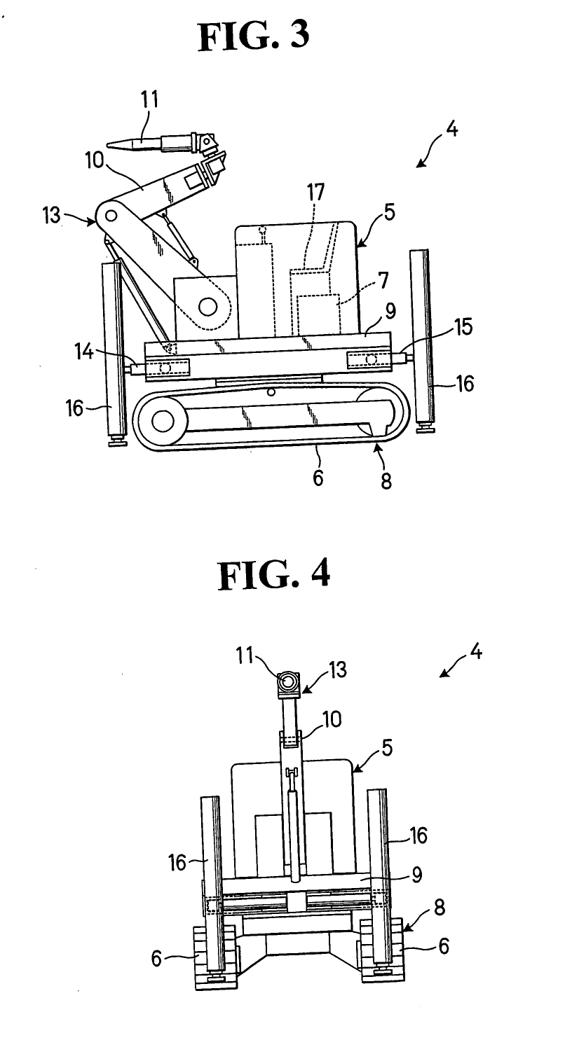

As shown in FIGS. 3-6, the scrapping machine 4 comprises a body; a running device 8; a scrapping machine body 13; and extensible legs 16.

The running device 8 is comprised of caterpillars 6 attached to both sides of the body 5, capable of running the body 5; and a hydraulic drive device 7, using in the hydraulic backhoe, driving the caterpillars 6.

The scrapping machine body 13 has the almost same mechanism of the mini backhoe, having a drive arm 10 that is attached, capable of rotating horizontal direction. A breaker 11 and a clasped crushing device 12 are attached to a tip portion of the drive arm 10 respectively.

The extensible legs 16 using at least four hydraulic cylinders are attached to forward-, backward-, right-and left portions at a base 9 of the body 5 via two hydraulic cylinders 14 and 15, capable of moving the base 9 up to an upper floor of the building 2.

The scrapping machine 4 can run by driving hydraulic drive device 7 as well as the conventional mini backhoe, and it can operate the breaker 11 and the clasped crushing device 12 or the drive arm 10 from a driver's seat 17 of the scrapping machine body 13.

Moreover, when the scrapping machine 4 moves to upper floor or works a higher place, the extensible legs 16 can expand and contract, and the hydraulic cylinders 14 and 15 can expand and contract.

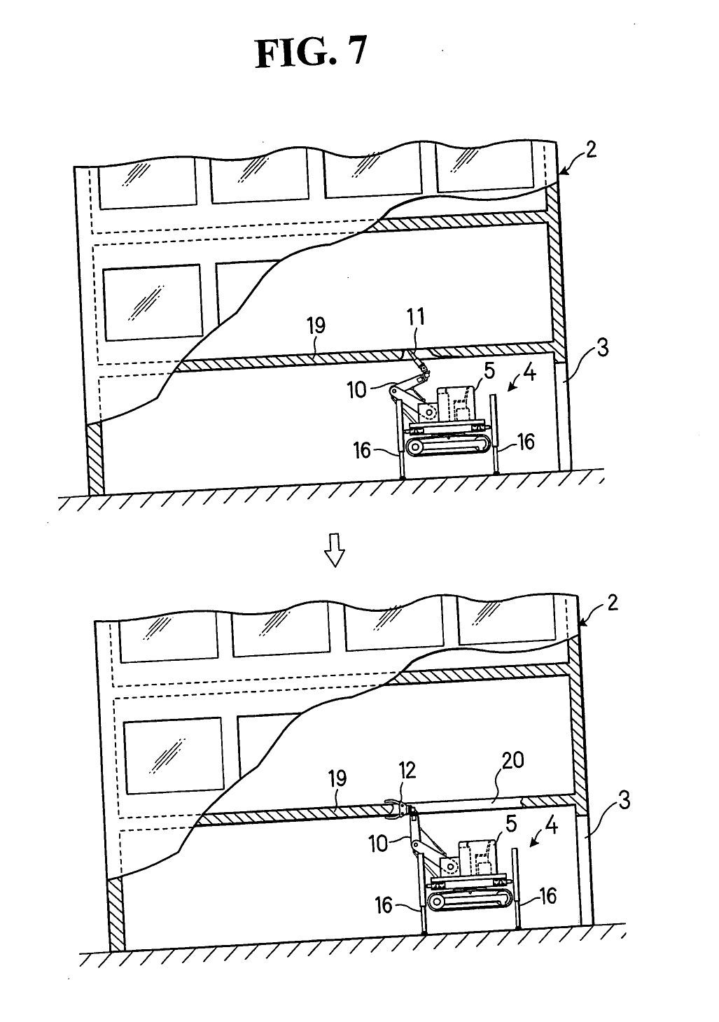

The numeral 18 shows a step for forming a movement hole 20 which is formed at a floor part 19 of the upper floor by the scrapping machine 4 after the movement process 1, the scrapping machine 4 can pass through the movement hole 20 and move to the upper floor. The breaker 11 attached to the tip portion of the drive arm 10 forms a hole 21, as shown in FIG. 7, then the clasped crushing device 12 is attached to the tip portion of the drive arm 10, and the floor part 19 is clasped and broken by the clasped crushing device 12, and the movement hole 20 is formed.

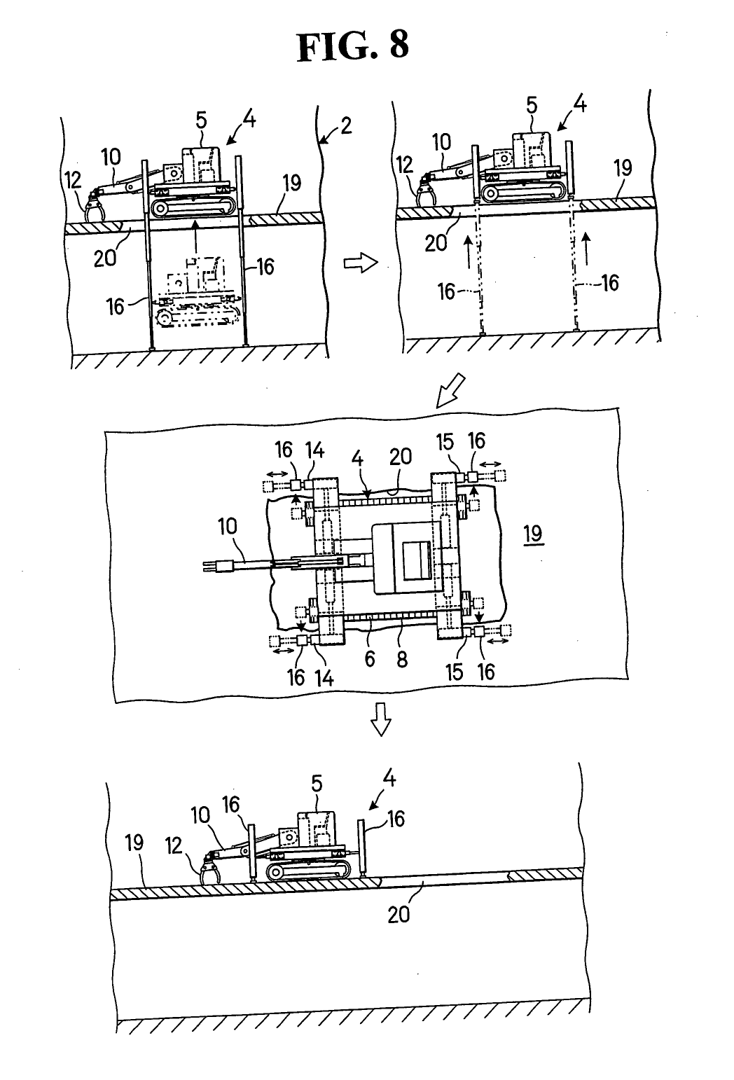

The numeral 22 shows a step for moving the scrapping machine 4 to the upper floor via the movement hole 20. In the movement process 22, the scrapping machine 4 may move to the upper floor by four winches. As shown in FIG. 8, after the extensible legs 16 extend, the scrapping machine 4 passes the movement hole 20. Then the bottom portion of the caterpillars 6 is placed at an upper portion of the floor part 19 of the upper floor, and the tip portion of the drive arm 10 is contacted at the floor part 19.

After that, one of the extensible legs 16 is contracted and the hydraulic cylinders 14 and 15 are acted and moved to forward-, backward-, left- and right directions, the extensible leg 16 locates so as to be supported by the floor part 19. After doing such work one by one and the extensible legs 16 locates so as to be supported by the floor part 19, the caterpillars 6 is located on the floor part 19 via the operating of the hydraulic cylinders 14 and 15 and run on the floor part 19 of the upper floor.

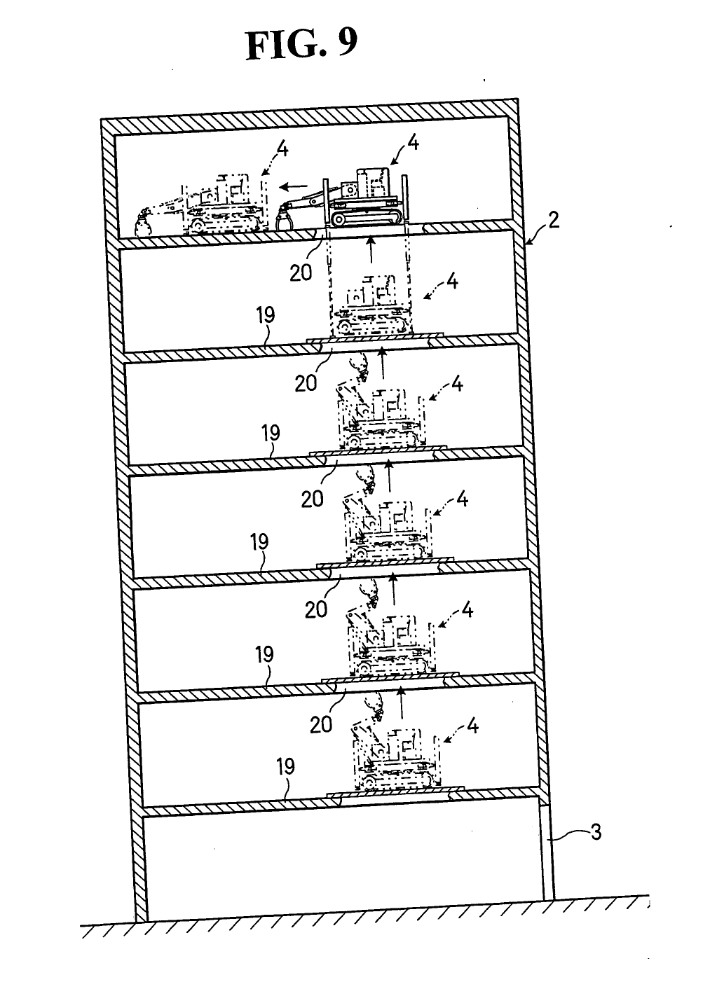

As shown in FIG. 9, the numeral 23 shows a step for moving the scrapping machine 4 to the highest floor after the hole formation process 18 and movement process 22 are performed one by one. In this step, the hole formation process 18 is operated that a support plate and support bar are arranged so as to locate the scrapping machine 4 above the movement hole 20 which is formed at the down stair when the movement hole 20 is formed at the same place of the movement hole 20 of the down stair.

On the other hand, when the movement hole 20 is formed at the different place of the movement hole 20 of the down stair, the movement hole 20 of the down stair leaves as it is.

As shown in FIG. 9, the numeral 24 shows a step for scrapping at the top part of the building 2 without the floor part located the scrapping machine 4, and the building is scrapped so as to place the demolition waste inside the building 2. In this step 24, the breaker 11 and clasped crushing device 12 are attached to the tip portion of the drive arm 10, and the demolition work is operated.

The numeral 26 shows a step for discharging the demolition waste 25 that produces at the scrapping process 24 through the movement hole 20 to the lower direction. In the discharging process 26, the scrapping machine 4 of a building performs, and it is performed by hand.

The numeral 27 shows a step of the demolition work to the lower floor. In this step 27, the scrapping machine 4 moves to the lower floor after the step 24 is performed, and the scrapping process 24 and discharging process 26 are performed one by one. The movement of the scrapping machine 4 is performed by extension and contraction of the extensible legs 16 and hydraulic cylinders 14 and 15.

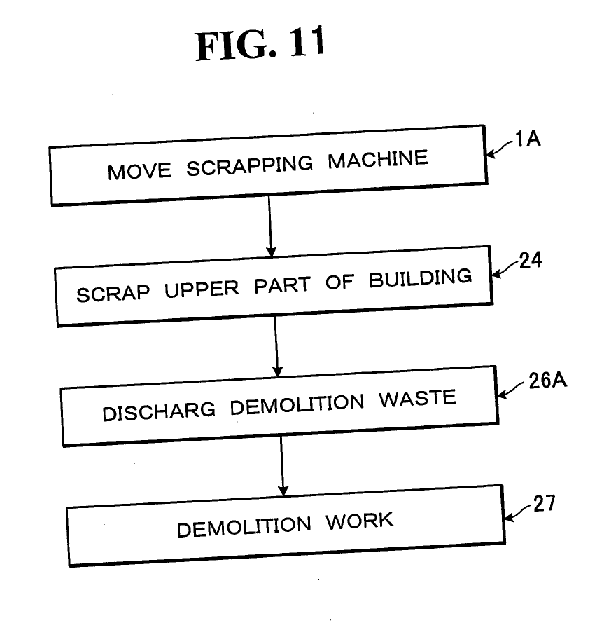

Other embodiments of the present invention will now be described with reference to FIGS. 11-85. In FIGS. 11-85, the same components as in the first embodiment described above with reference to FIGS. 11-85 are designated by the same reference numerals and therefore will not be further explained in great detail.

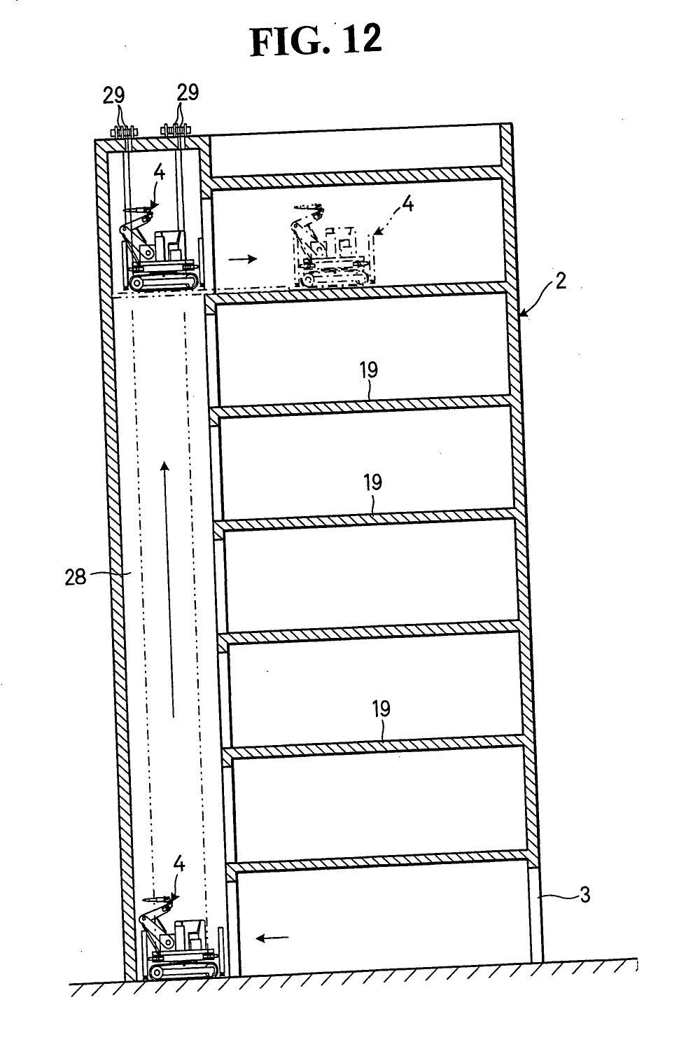

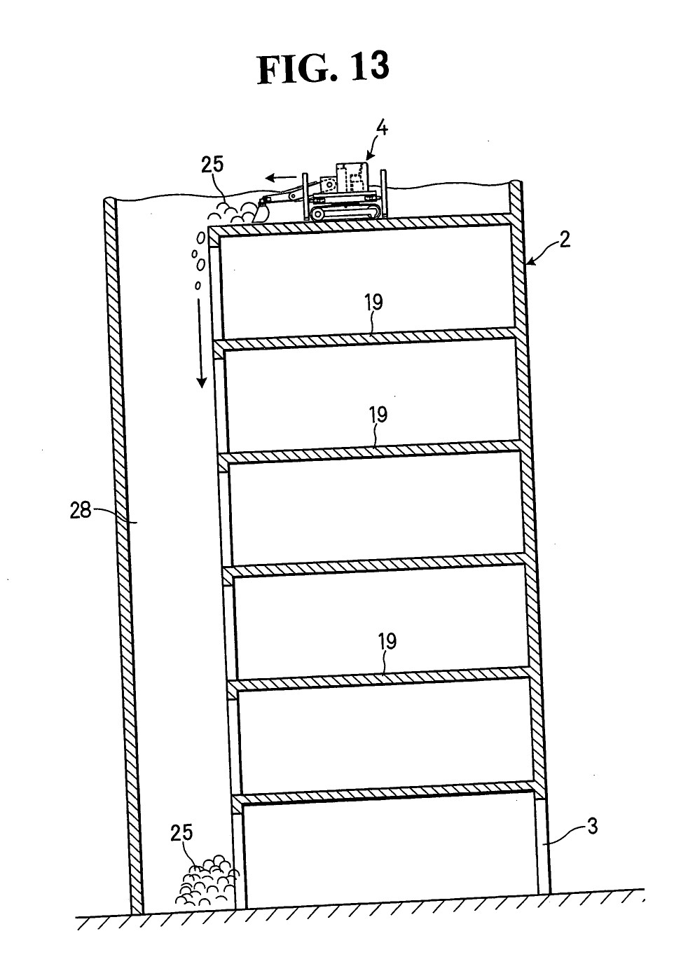

A second embodiment of the present invention is shown in FIGS. 11-13. It is distinguished from the first embodiment in that a movement process 1A that the scrapping machine 4 moves to the highest floor through an elevator hole 28 is performed, and a process 26A for discharging the demolition waste through the elevator hole 28. A scrapping method with the movement process 1A and discharging process 26A according to the second embodiment has similar advantages to that according to the first embodiment.

In addition, removal of an elevator and a disassembling the entrance part of the elevator hole 28 are performed beforehand before the movement of the scrapping machine 4 through the elevator hole 28 is used in four winches 29.

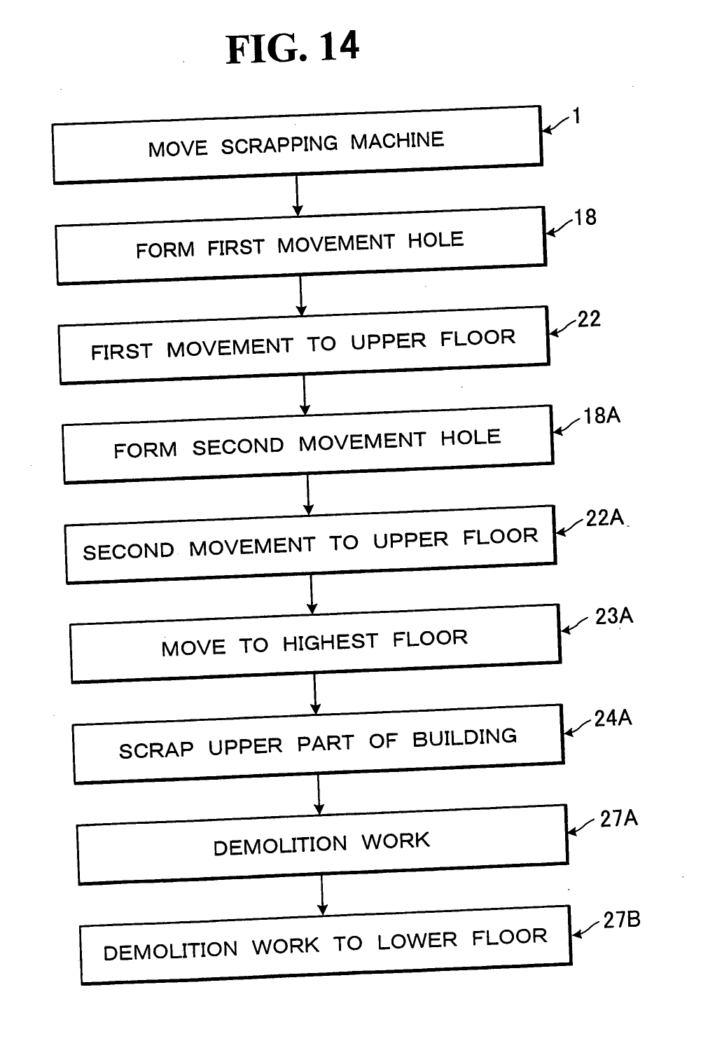

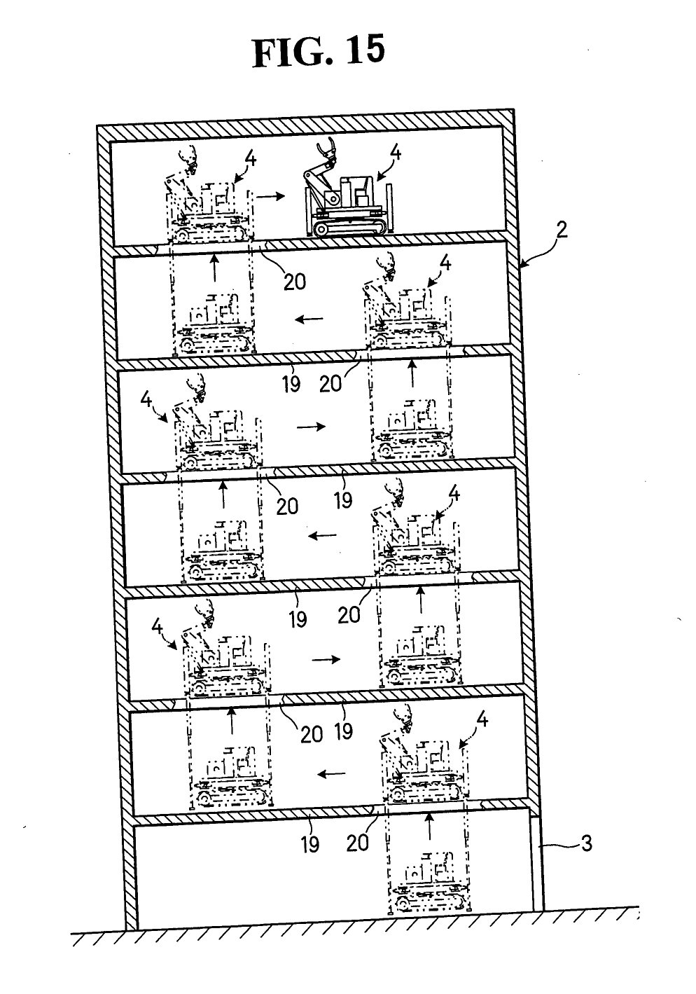

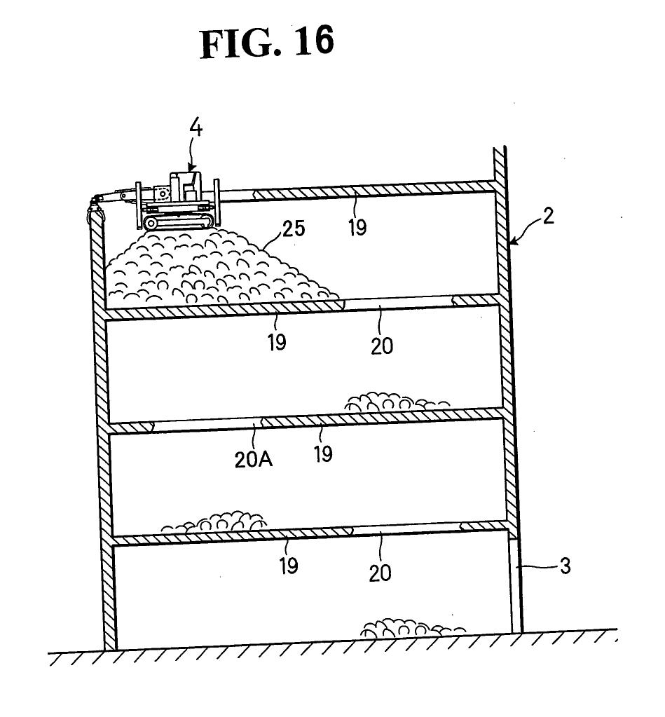

A third embodiment of the present invention is shown in FIGS. 14-16. It is distinguished from the first embodiment in that a scrapping method is composed of a movement process 1; a forming process 18 for the first movement hole 20; a first movement process 22 to the upper floor; a forming process 18A for the second movement hole 20A; a second movement process 22 to the upper floor, a process 23A for moving the scrapping machine 4 to the highest floor; a process 24A for scrapping at the top part of the building 2; a process 27A of the demolition work; and a process 27B of the demolition work to the lower floor.

In the forming process 18, the first movement hole 20 formed to move the scrapping machine 4 to the upper floor after the movement process 1 is performed.

Then the scrapping machine 4 moves through the first movement hole 20 in the first movement process 22.

In the forming process 18A, the second movement hole 20A to move the scrapping machine 4 to the upper floor is formed on the upper floor portion located at a different place from the first movement hole 20.

Then the scrapping machine 4 moves through the second movement hole 20A in the second movement process 22A.

Then the scrapping machine 4 moves to the highest floor of the building in the process 23A after the forming process 18, the first movement process 22, the forming process 18A and the second movement process 22A are performed one by one.

After that, the scrapping machine 4 scraps so that the demolition waste is located inside the building, and it is discharged to the lower floor, and the scrapping machine 4 located on the floor or the demolition waste also scraps the floor part of the upper portion of the building in the process 24A.

In the process 27A of the demolition work, the demolition waste is discharged through the movement holes 20 and 20A. The scrapping machine 4 scraps so that the demolition waste is located inside the building, and the demolition waste is discharged through the movement holes 20 and 20A. Then the scrapping machine 4 located on the floor or the demolition waste also scraps the floor part.

Then the process 27A is repeated, and the scrapping machine 4 scraps to the lower floor in the process 27B of the demolition work.

A scrapping method according to the third embodiment has similar advantages to that according to the first embodiment.

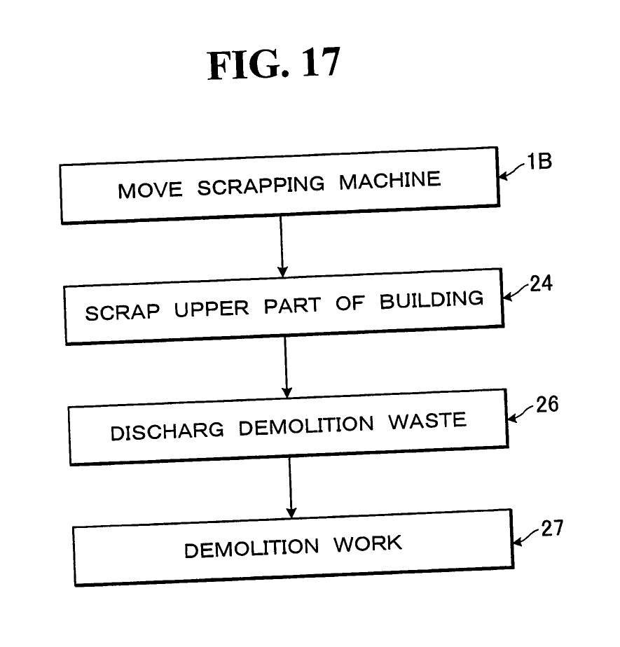

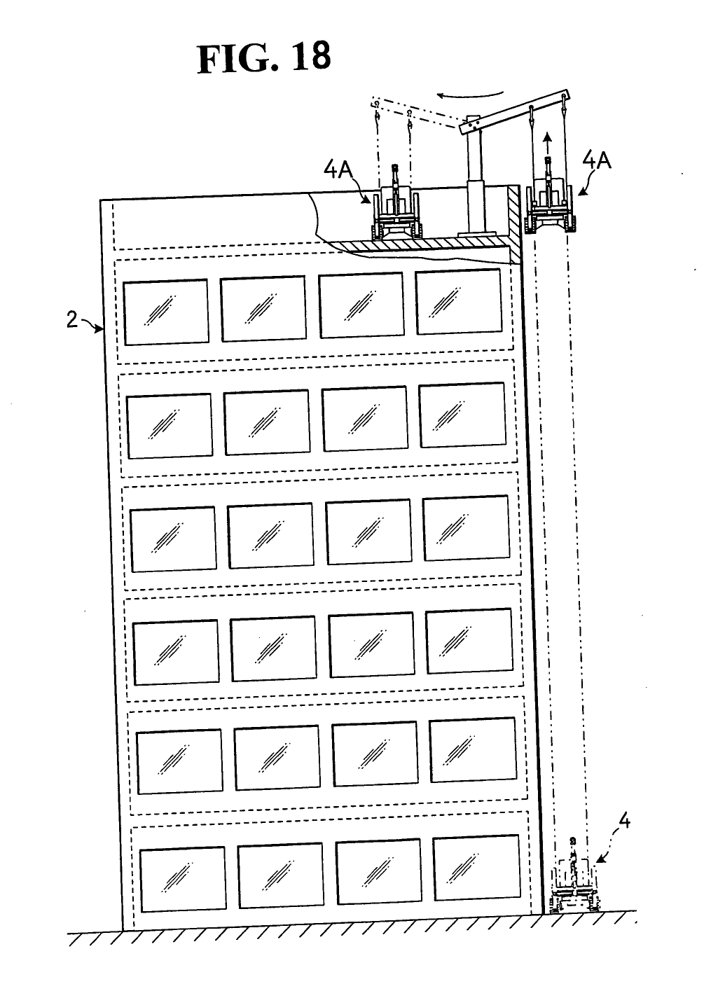

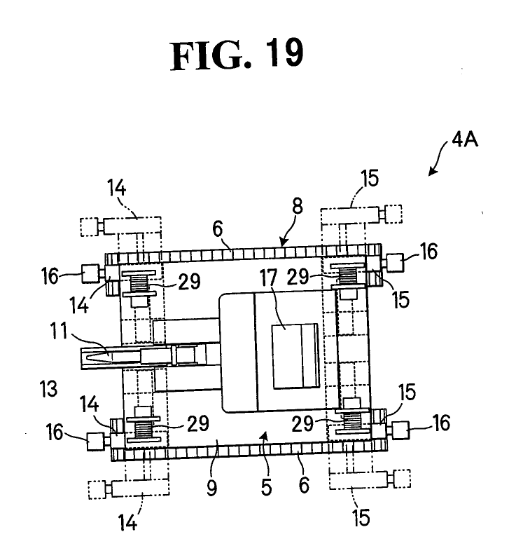

A four embodiment of the present invention is shown in FIGS. 17-19. It is distinguished from the first embodiment in that a movement process 1B is performed. In this process 1B, a scrapping machine 4A is attached winches 29 at forward-, backward-, left- and right portions thereof, and it moves to the roof part of the building 2 by the winches 29. A scrapping method with the movement process 1B according to the fourth embodiment may be operated.

In addition, the scrapping machine 4A may be lifted up using the crane installed in the roof.

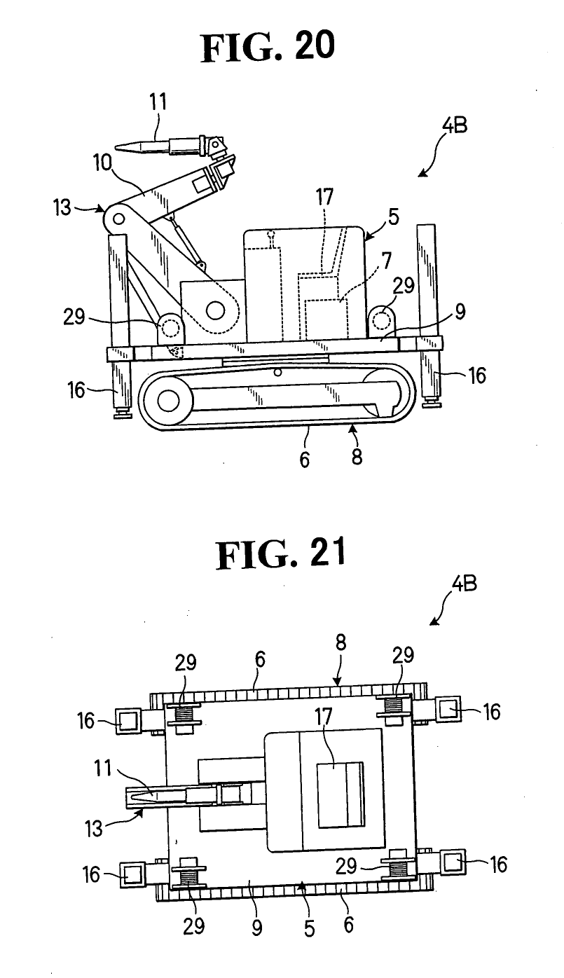

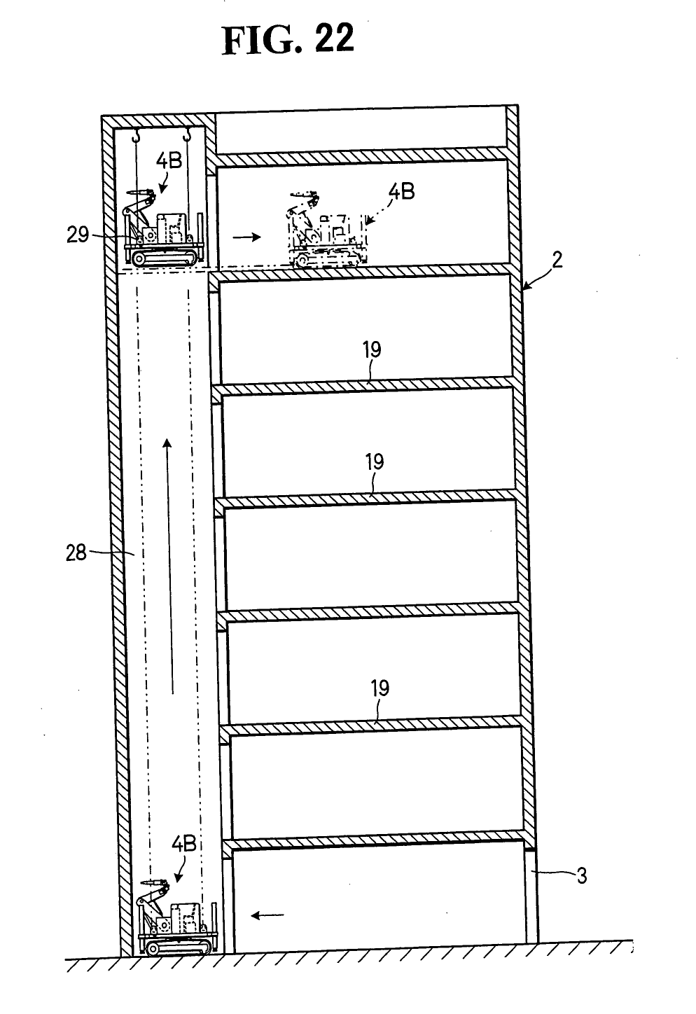

A fifth embodiment of the present invention is shown in FIGS. 20-22. It is distinguished from the first embodiment in that the extensible legs 16 using four hydraulic cylinders are attached to forward-, backward-, left- and right portions of the body 5 or the base 9 of the body 5, capable of working with vertical movement, and winches 29 are attached to forward-, backward-, left- and right portions to the base 9. A scrapping machine 4B can move through the hole 28 and move to a roof part easily from the outside of a building

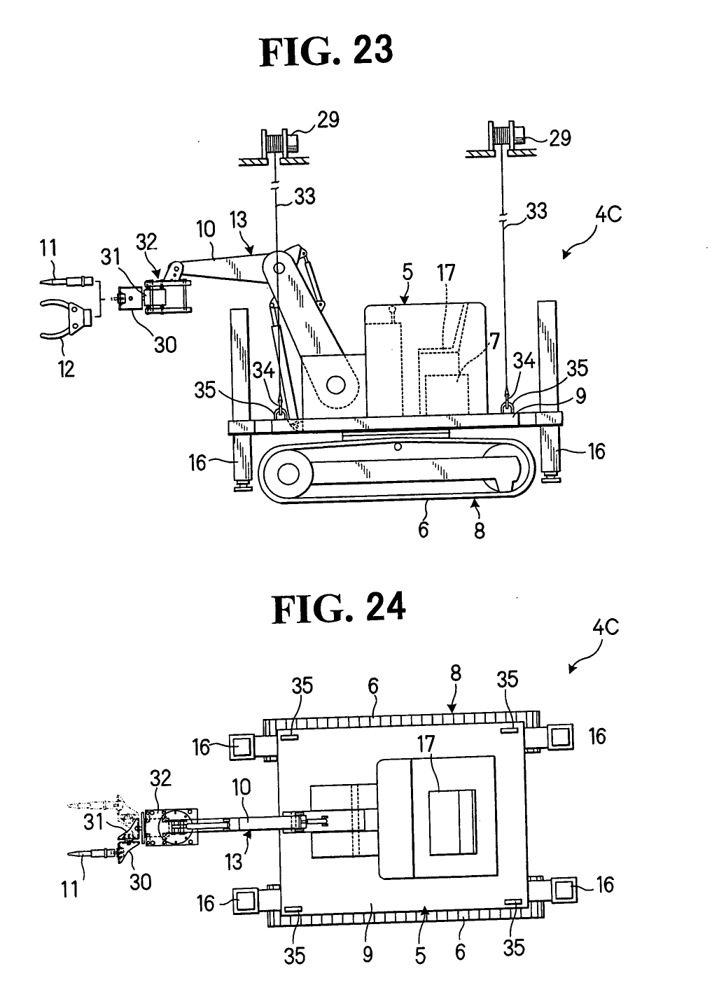

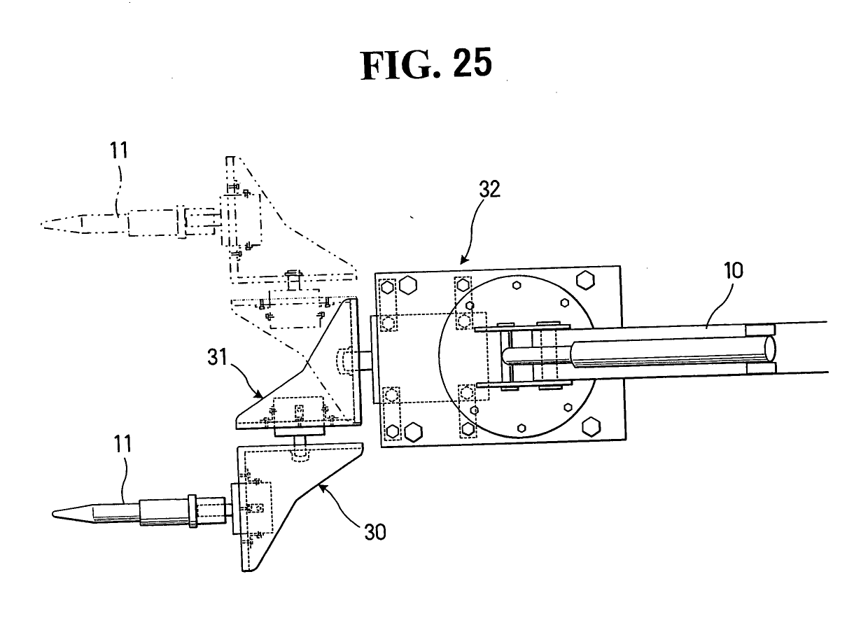

A sixth embodiment of the present invention is shown in FIGS. 23-25. It is distinguished from the first embodiment in that the breaker 11 and clasped crushing device 12 are attached to the tip portion of the drive arm 10 via a mount 32 interposed a horizontal rotatable mechanism 30 and a vertical rotatable mechanism 31, and four hooks 35 is attached to forward-, backward-, left- and right portions to the base 9, attaching to engage pieces 34 which are attached to tip portions of wires 33. A scrapping machine 4C according to the sixth embodiment has similar advantages to that according to the fifth embodiment.

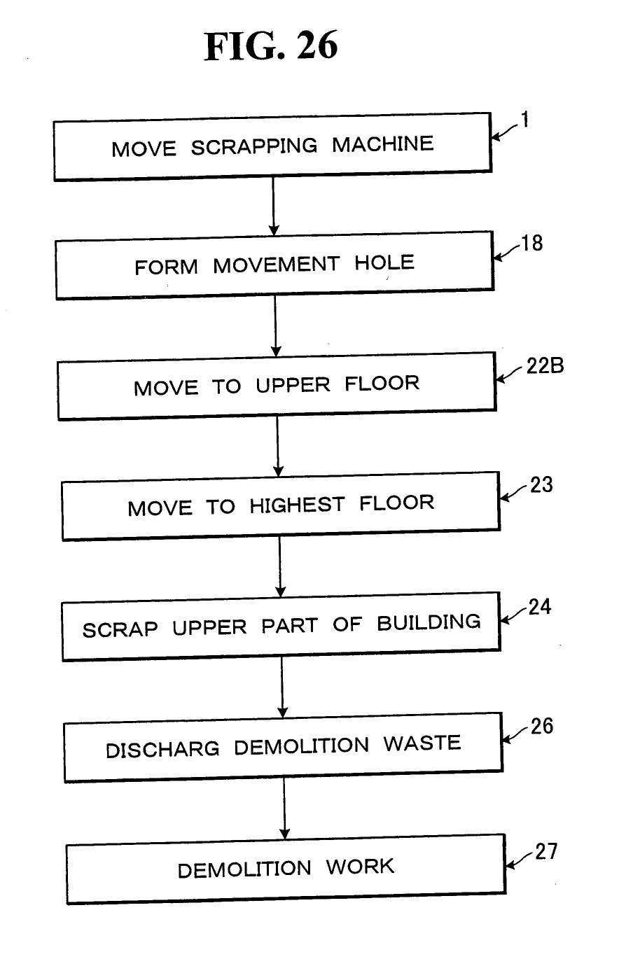

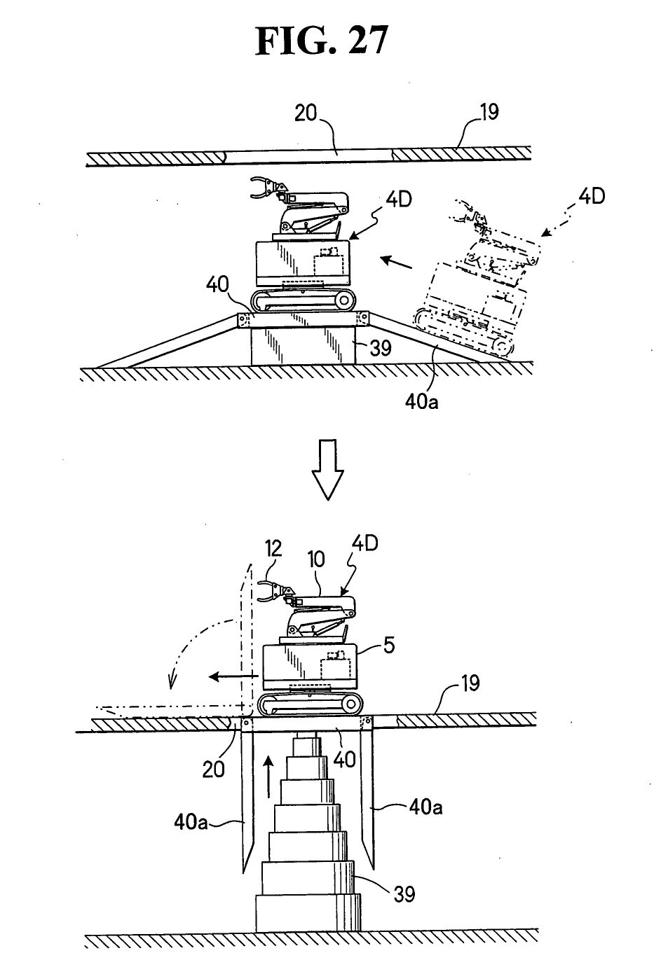

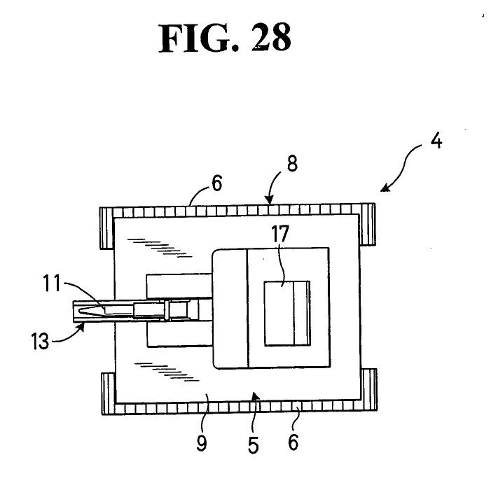

A seventh embodiment of the present invention is shown in FIGS. 26-28. It is distinguished from the first embodiment in that a scrapping machine 4D which is not installing the extensible leg in the d-, backward-, left- and right portions of the base 9 can move to an upper directions, and the scrapping machine 4D includes a extensible stand 40, capable of lifting the end portion thereof by a hydraulic cylinder 39, having guide plates 40a pivotably attached to both ends thereof. A scrapping method with movement process 22B to the upper floor for a scrapping machine 4D may be operated.

In addition, a guide plate 40a may be used at one end part of the extensible stand 40. In this case, when the scrapping machine 4 is located on the extensible stand 40, it may run on the floor part of the upper floor after the guide plate 40a rotates to an upper direction and raises, and it is located on the upper floor.

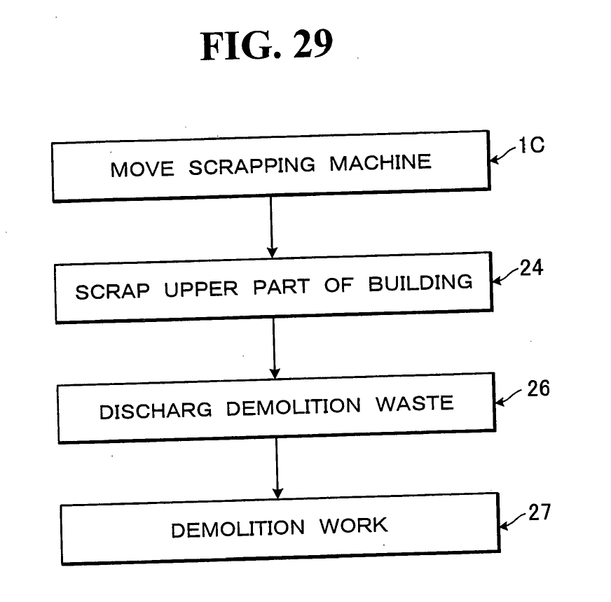

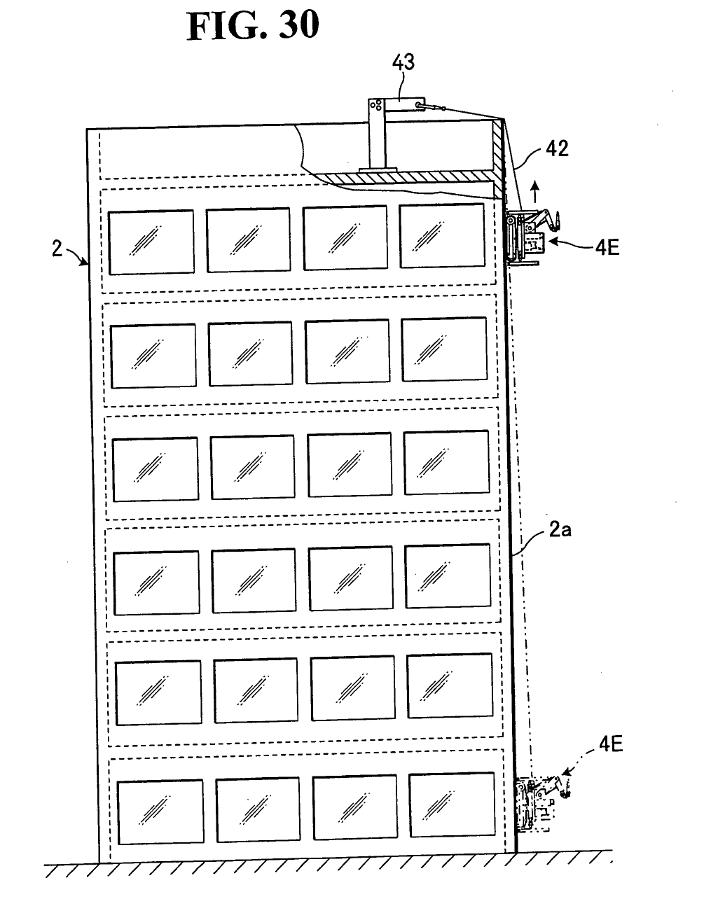

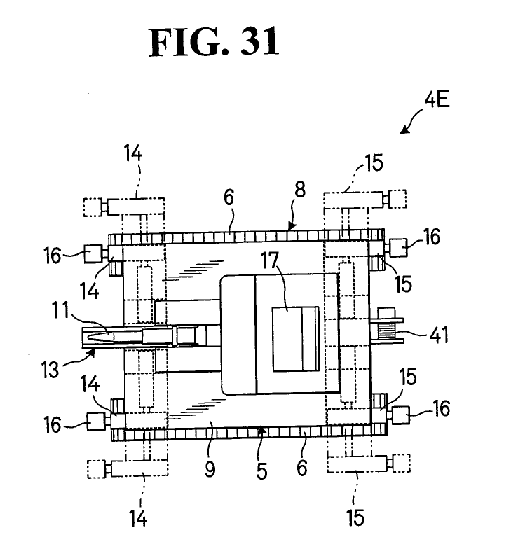

An eighth embodiment of the present invention is shown in FIGS. 29-31. It is distinguished from the first embodiment in that a movement process 1C is performed. A scrapping machine 4E is installed a winch 41. A wire 42 of the winch 41 of scrapping machine 4E is fixed to a building body via a tip part of an arm 43 installed in an upper part of the disassembled building 2. Then the wire 42is wound by the winch 41. After that, the scrapping machine 4E runs on the outer wall of the building 2, and it moves to the roof part.

A scrapping method with movement process 1C by a scrapping machine 4E may be operated.

In addition, in this embodiment, the winch 41 is attached to the upper portion of the building, and the wire 42 can move slidably via a pulley attached to the tip portion of the arm 43.

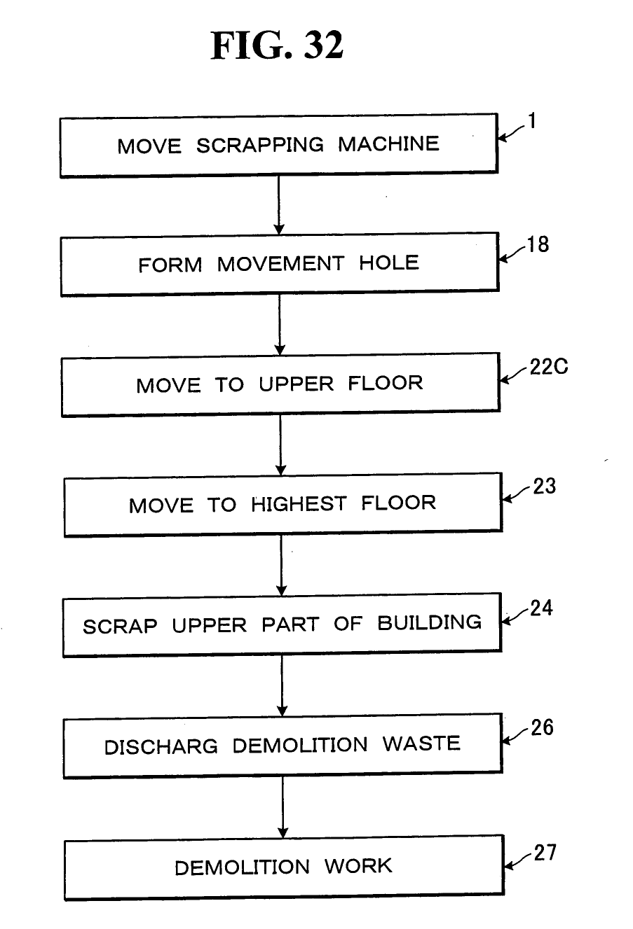

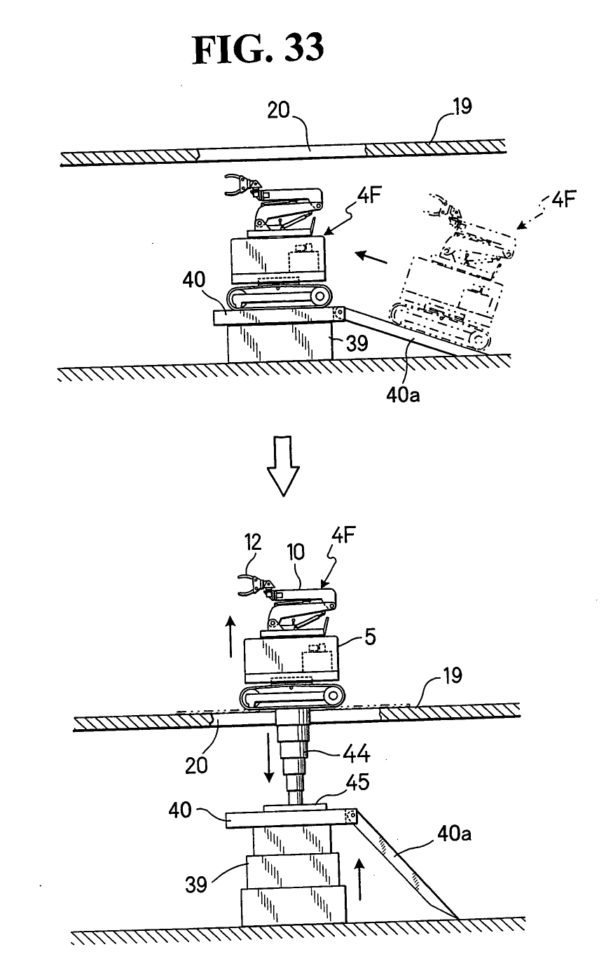

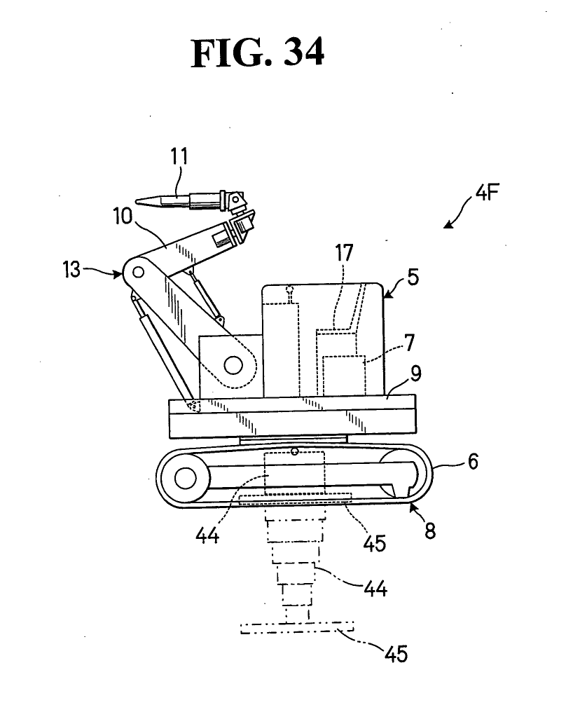

A ninth embodiment of the present invention is shown in FIGS. 32-34. It is distinguished from the first embodiment in that a scrapping machine 4F has a support stand 45 with a hydraulic cylinder 44 which projects under the body 5, the scrapping machine 4F moves up using the extensible stand 40 in a movement process 22C. A scrapping method with the movement process 22C to the upper floor by a scrapping machine 4F may be operated.

In this case, since the support stand 45 of the scrapping machine 4F can expand and contract, the extensible stand 40 with a small stroke of expansion and contraction can be used.

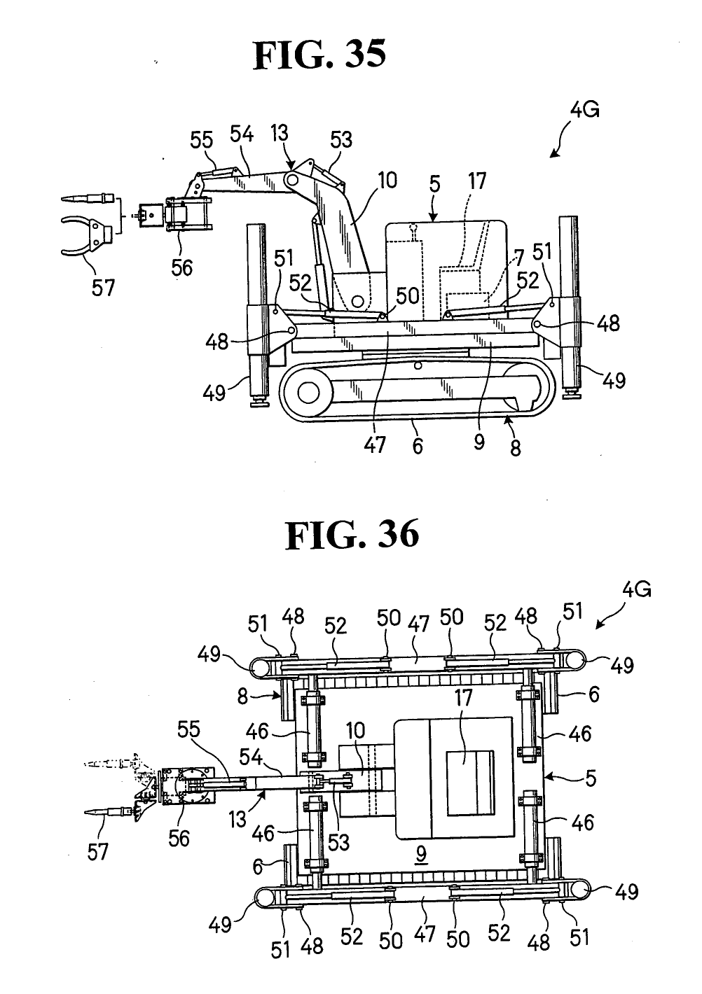

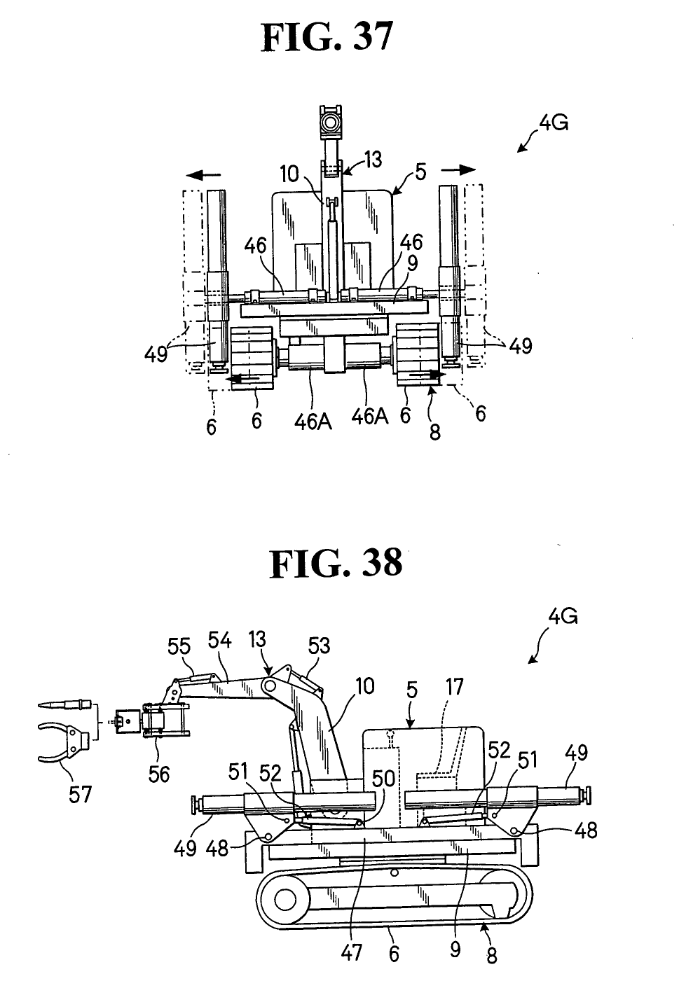

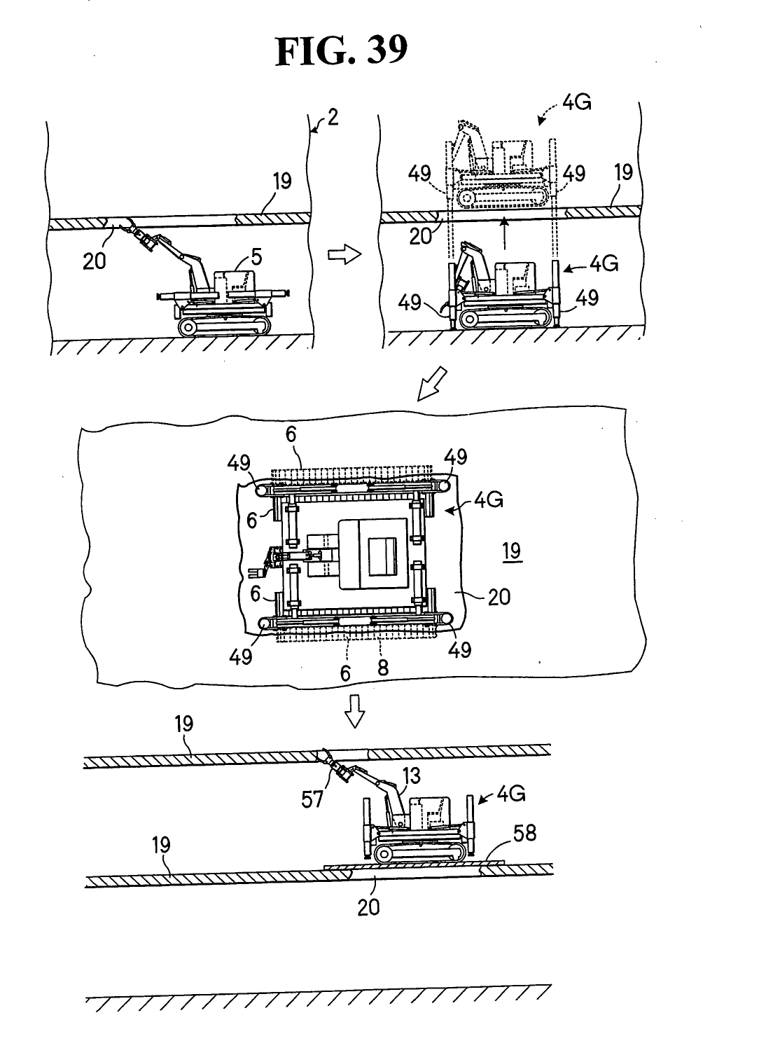

A tenth embodiment of the present invention is shown in FIGS. 35-39. It is distinguished from the fifth embodiment in that a scrapping machine 4G has the caterpillars 6 attached to the body 5 via two pairs of hydraulic cylinders 46A, as a movement device for caterpillar, so as to project at a voluntary length and further comprises left and right of support members 47 for extensible legs which is formed in the shape of a bar; extensible legs 49; hydraulic cylinders 52 for storing the extensible legs; a pivotable boom 54; an attachment 56; and a crushing machine 57.

The support members 47 are attached projectably to left and right sides of the upper portion rather than the top end portion of the body 5 by the hydraulic cylinders 46, projecting to an outer direction rather than front and back ends of the caterpillars 6.

The extensible legs 49 are supported pivotably by pivot pins 48 to the front and back ends of the support members 47, having the hydraulic cylinders which is positioned the lower portion thereof located above the lower end portion of the caterpillars 6 in a standing and storing manner and positioned the lower portion of the caterpillars 6 located above the floor part 19 of the upper floor in a extending manner.

The hydraulic cylinders 52 store the extensible legs 49 on the support members 47 when in not use, one end thereof supported pivotably at a portion adjacent a center portion of the support members 47 by pivot pins 50, and another end thereof supported pivotably at the extensible legs 49 by pivot pins 51.

The pivotable boom 54 is attached pivotably to a tip portion of the drive arm 10 of the scrapping machine body 13 by the hydraulic cylinder 53 as the same as the conventional backhoe.

The attachment 56 is attached to a tip portion of the pivotable boom 54 so as to rotate by the hydraulic cylinder 55.

The crushing machine 57, such as, for example the breaker and clasped crushing device, is attached removably to the attachment 56.

In the scrapping machine 4G, the scrapping machine body 13 horizontally rotates, and the drive arm 10, pivotable boom 54, attachment 56, crushing machine 57 are operated. The extensible legs 49 stand by operating the hydraulic cylinders 52 after the movement hole 20 is formed on the floor part of the upper floor. After that, the extensible legs 49 are extended, and the lower portion of the caterpillars 6 are positioned above the floor part 19 of the upper floor.

Then the hydraulic cylinders 46 as the movement device for caterpillar are operated, and the caterpillars 6 moves to an outward direction so as to be supported at the floor part at both sides of the movement hole 20.

The extensible legs 49 extend, and the caterpillars 6 are supported on the floor part 19 of the upper floor.

Under this condition, after the movement hole 20 is formed at the floor part 19 of the next upper floor, the hydraulic cylinders 46 as a movement device for caterpillar is started to work, and the support members 47 project to the outer direction.

Next, after the extensible legs 49 expand, the lower parts of the extensible legs 49 touch, and the body 5 moves upwards a little. After that, the hydraulic cylinders 46 as the movement device for caterpillar are operated, and the caterpillars 6 are stored, and then the extensible legs 49 are expanded further, and the lower ends of the caterpillars 6 locate on the floor part 19 of the upper floor. Therefore, the scrapping machine 4G moves upward one by one

In addition, when support plates 58 are used to support the extensible legs 49, it can cover a part of the movement hole 20 located at the extensible legs 49 when in movement to the upper floor.

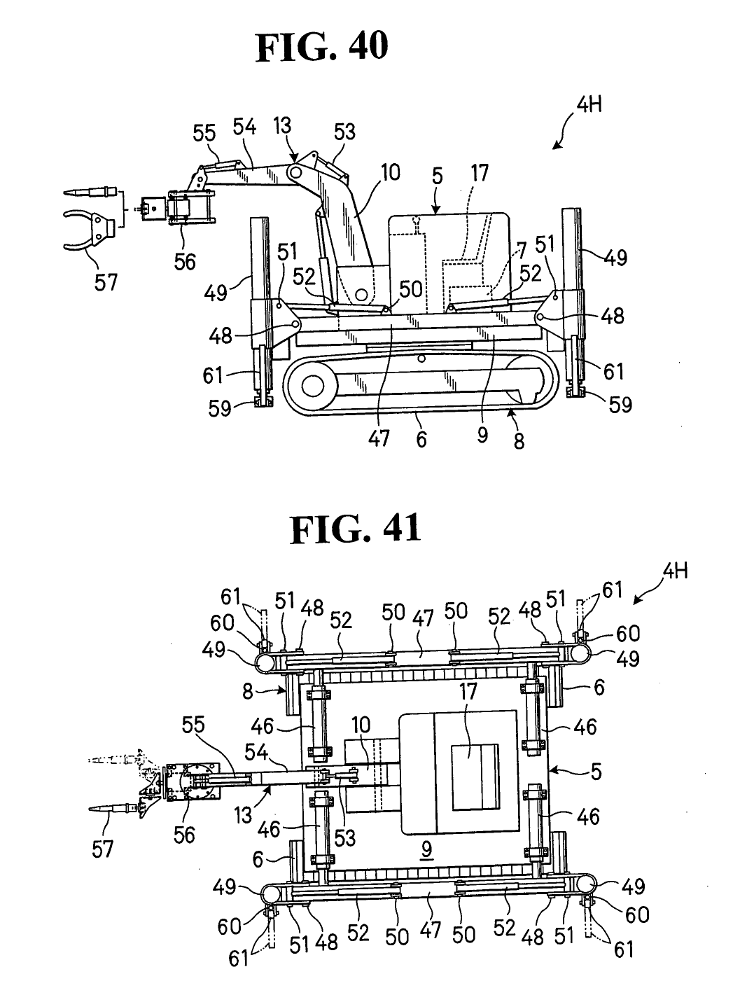

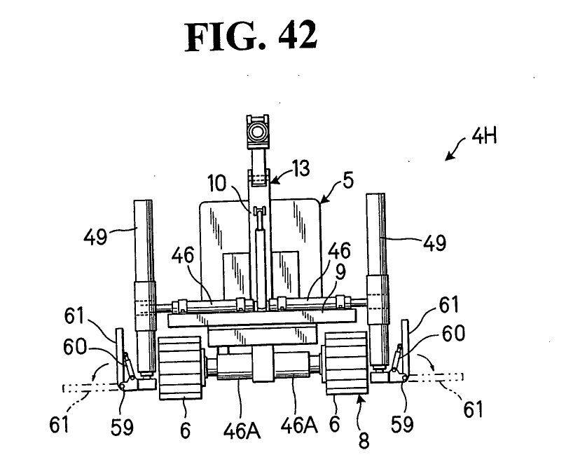

An eleventh embodiment of the present invention is shown in FIGS. 40-42. It is distinguished from the tenth embodiment in that back ends of leg pieces 61 are pivoted the lower end of the extensible legs 49 by the pivot pins 59, storing along the extensible legs 49 when in not use, operating by the hydraulic cylinders 60 so as to project to an outward direction when in use. A scrapping machine 4H with the leg pieces 61 according to the eleventh embodiment has similar advantages to that according to the tenth embodiment, and the leg pieces 61 can be stored and projected so that the scrapping machine 4H can be supported by the leg pieces 61 which supports around the movement hole 20 of the floor part 19 each floor and moves without the support plate.

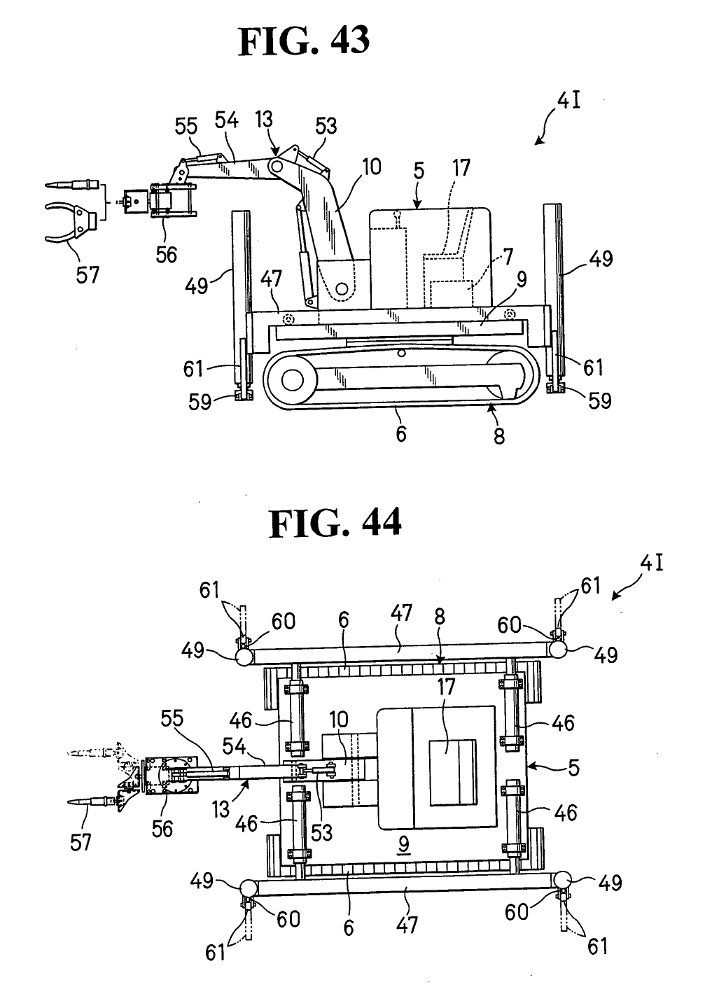

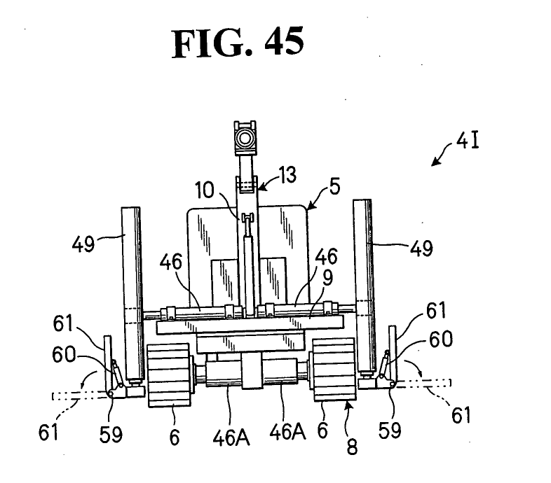

A twelfth embodiment of the present invention is shown in FIGS. 43-45. It is distinguished from the first embodiment in that the extensible legs 49 located at forward-, backward-, left- and right portions are attached fixedly at forward- and backward ends of the support members 47.

A scrapping machine 4I according to the twelfth embodiment has similar advantages to that according to the eleventh embodiment.

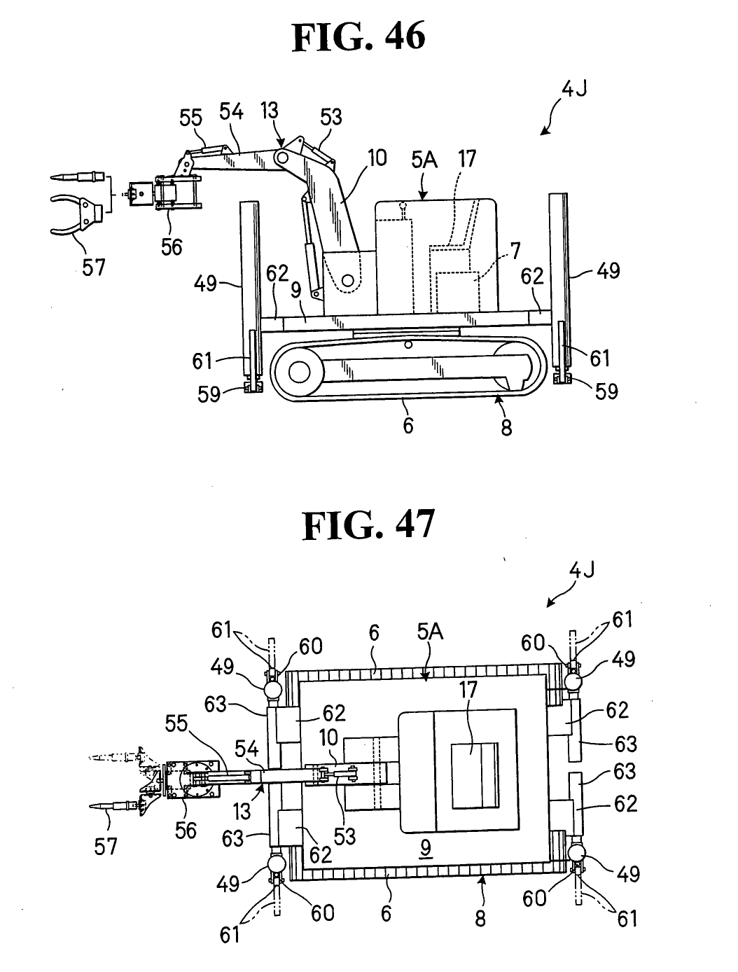

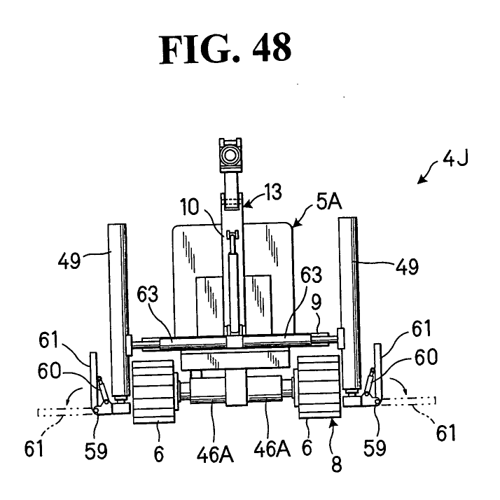

A thirteenth embodiment of the present invention is shown in FIGS. 46-48. It is distinguished from the twelfth embodiment in that a scrapping machine 4J further includes a body 5A having attachments 62 for support members of the extensible legs, positioning above the upper end portion of the caterpillars 6 and outside the front and back ends of the caterpillars 6; hydraulic cylinders 63 as the support members of the extensible legs, projecting to an outer direction to the attachments 62; and the extensible legs 49 at forward-, backward-, left- and right parts fixed to a tip portion of the hydraulic cylinders 63. The scrapping machine 4J according to the thirteenth embodiment has similar advantages to that according to the twelfth embodiment

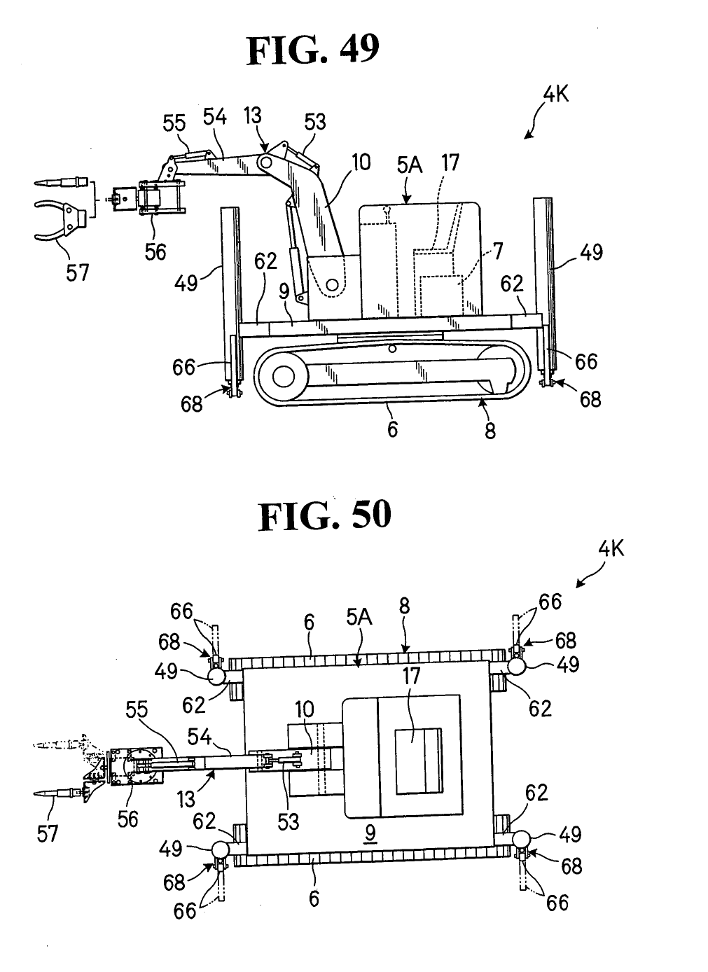

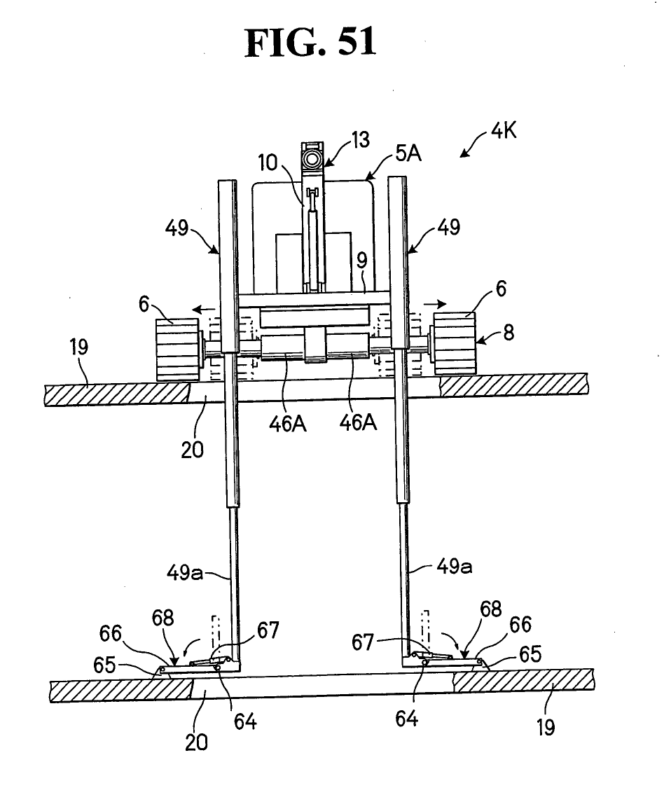

A fourteenth embodiment of the present invention is shown in FIGS. 49-51. It is distinguished from the twelfth embodiment in that the extensible legs 49 is attached fixedly to the attachments 62, locating and attaching to the parts outwardly rather than the front and backward direction of the caterpillars 6, at the body 5A; extensible leg piece bodies 66 are attached rotatably to the lower parts of the lower extensible legs 49a via pivot pins 64, having support pieces 65 attached rotatably to tip portions thereof by its weight; and extensible leg pieces 68 includes hydraulic cylinders 67 for rotating the extensible leg piece bodies, attaching rotatably so as to store and use. In a scrapping machine 4K, the extensible leg pieces 68 projects outwardly, the extensible legs 49 extends, the caterpillars 6 projects outwardly, the extensible leg pieces 68 are stored, and the extensible legs 49 contract. Therefore, it can move through the movement hole 20 which is formed at the upper floor.

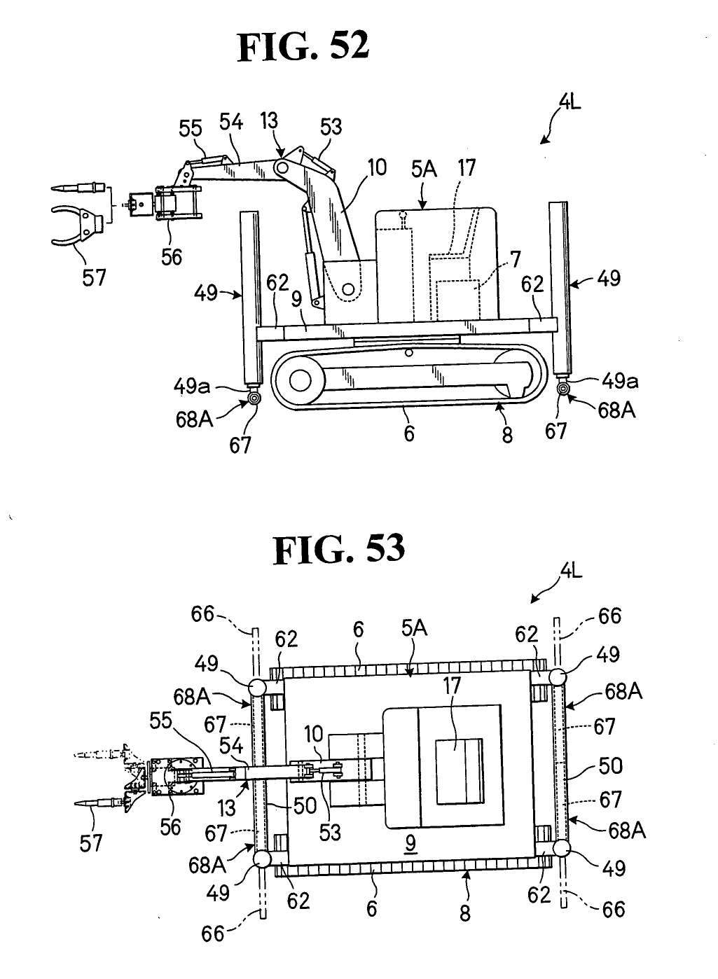

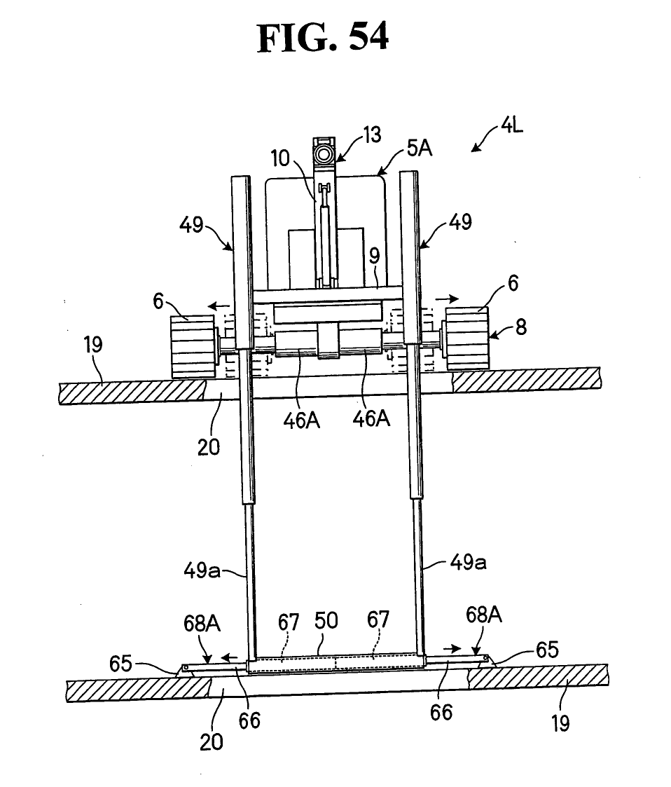

A fifteenth embodiment of the present invention is shown in FIGS. 52-54. It is distinguished from the fourteenth embodiment in that further comprises extensible leg pieces 68A includes support members 50 attached to the lower portions of the front and backward lower extensible legs 49a; and the extensible leg piece bodies 66 attached so as to project outwardly via the hydraulic cylinders 67 rather than the both ends of the support members 50. A scrapping machine 4L according to the fifteenth embodiment has similar advantages to that according to the fourteenth embodiment.

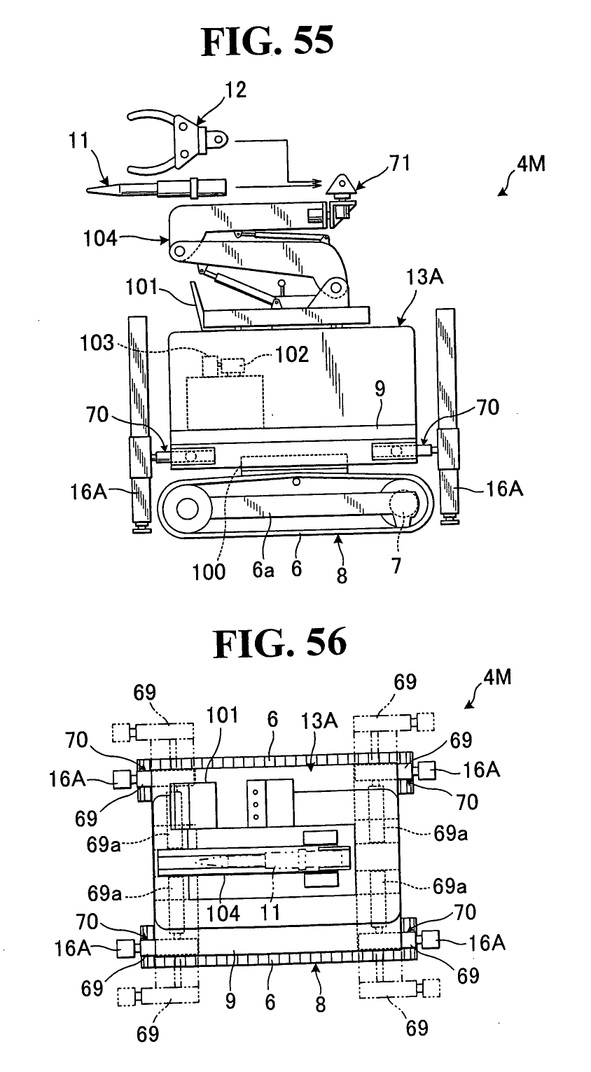

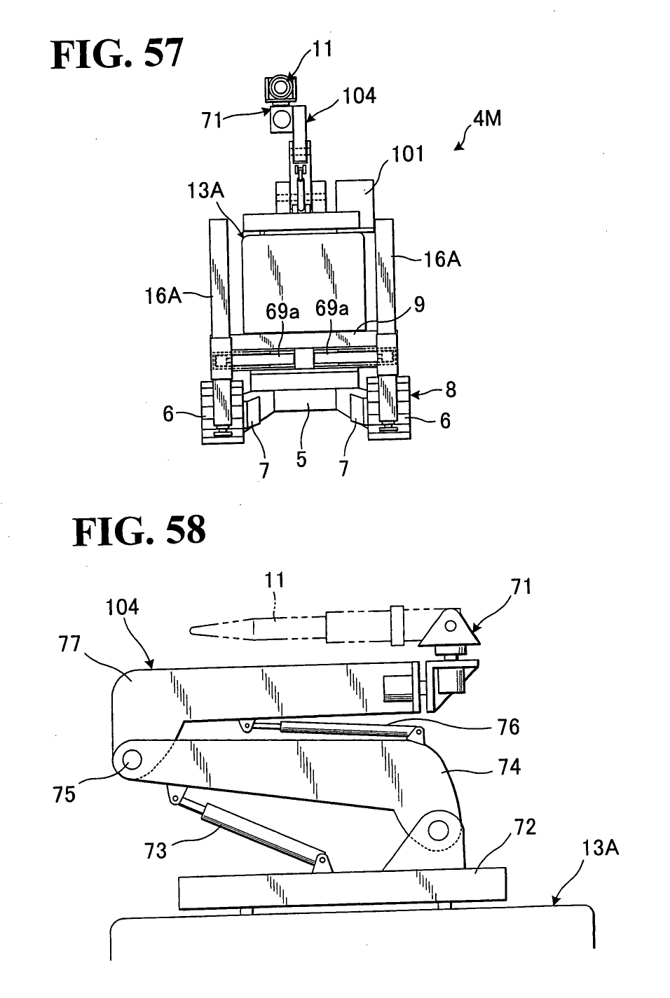

A sixteenth embodiment of the present invention is shown in FIGS. 55-66. It is distinguished from the first embodiment in that a scrapping machine 4M comprises the body 5; the running device 8 including the caterpillars 6 attached to both sides of the body 5, capable of running the body 5 and the hydraulic drive device 7, using in the hydraulic backhoe, driving the caterpillars 6; a scrapping machine body 13A attached rotatably to the body 5 to a horizontal direction via a rotation device 100, having a driver's seat 101, a motor 102, a hydraulic pump 103 and a drive arm 104; extensible legs 16A attached to forward-, backward-, left- and right parts of the base 9 of the body 5 via a movement mechanisms 70 to forward-, backward-, left- and right directions with hydraulic cylinders 69 and 69a, having the hydraulic cylinders capable of moving the body 5 on the upper floor; and attachment for a crushing machine 71 attached to the tip portion of the drive arm 104, having the crushing machine including the breaker 11 and a clasped crushing device 12 attached detachably at the tip portion thereof which drives rotatably.

As shown in FIG. 58, the drive arm 104 comprises a standing-up link 74 which rotates in the vertical direction by standing-up hydraulic cylinder 73 to a frame 72 of the scrapping machine body 13A; and a rotation boom 77 which rotates by a rotation hydraulic cylinder 76 pivoted rotatably by a pivot pin 75 so as to contain in the upper part of the standing-up link 74.

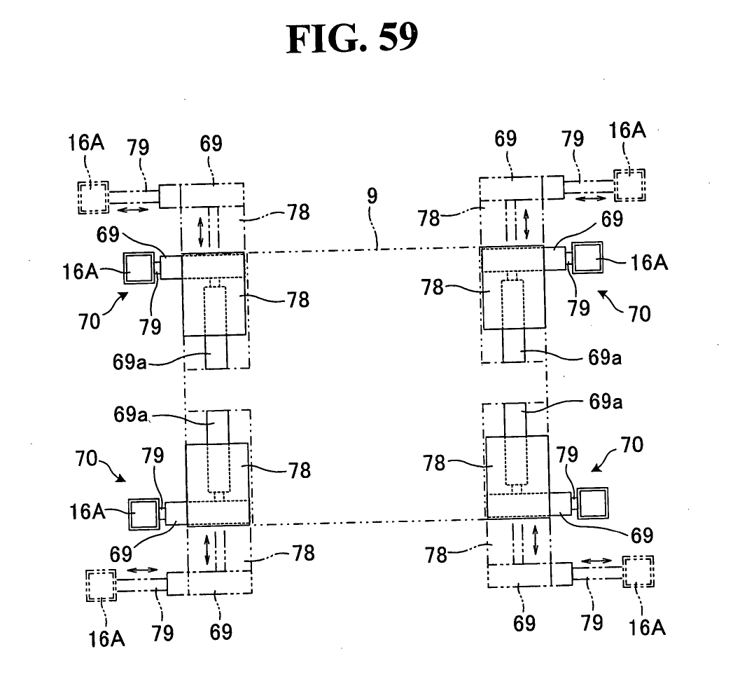

As shown in FIG. 59, the movement mechanisms 70 to forward-, backward-, left- and right directions further comprises the hydraulic cylinders 69 to forward-, backward directions attached a back end portion thereof to the forward-, backward-, left- and right parts of the plate 9 of the body 5 to fix slide movement members 78, fixing the fixed portions of the extensible legs 16A to the tip portions of extensible legs 79; and the hydraulic cylinders 69a, allowing the hydraulic cylinders 69 to move to left- and right directions.

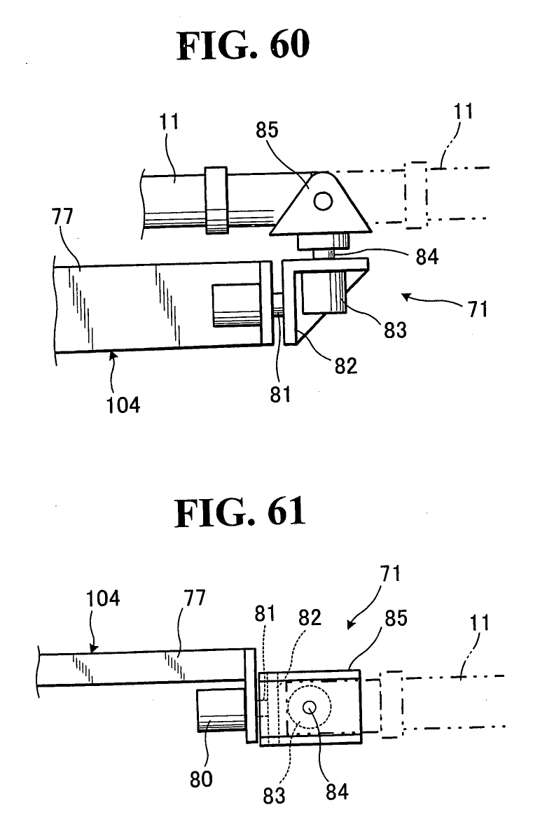

As shown in FIGS. 60 and 61, the attachment 71 for a crushing machine further includes a hydraulic motor 80 for horizontal rotation; a rotation support body 82; a hydraulic motor 83 for vertical rotation; and a mount 85.

The hydraulic motor 80 is attached to a tip portion of the rotation boom 77 of the drive arm 68.

The rotation support body 82 is attached the level portion thereof to a drive shaft 81 of the hydraulic motor 80, having a mount surface formed in the shape of a L-letter.

The hydraulic motor 83 is provided fixedly at a vertical portion of the rotation support body 82.

The mount 85 is provided fixedly at a drive shaft 84 of the hydraulic motor 83, attaching the crushing machine such as the breaker 11 and clasped crushing device 12.

The scrapping machine 4M operates the hydraulic drive device 7 as well as the conventional hydraulic backhoe etc. and drives the running device 8. Then it moves into the building 2 which is disassembled.

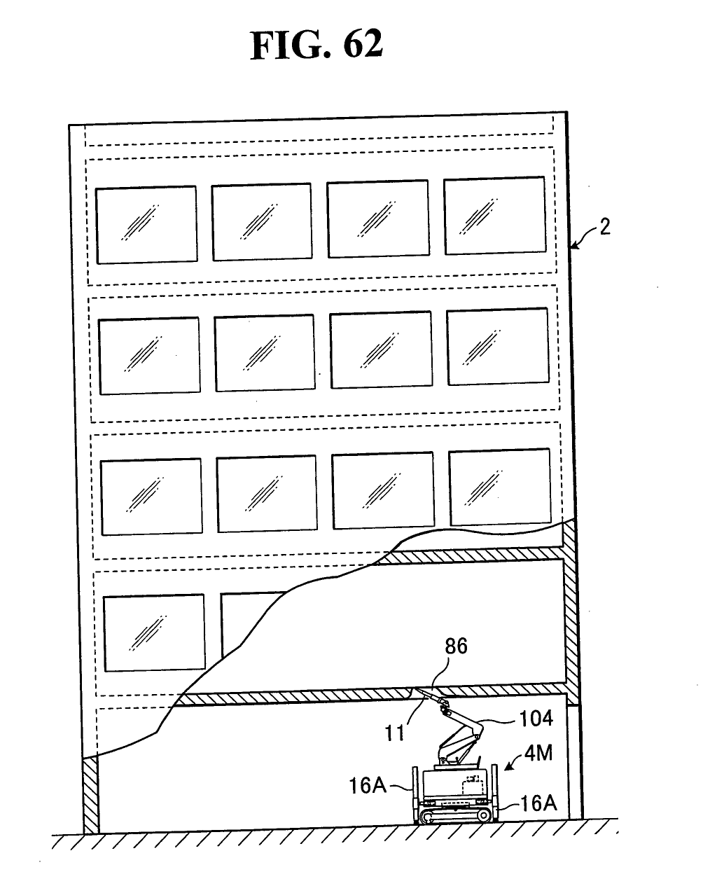

Next, the breaker 11 is attached to the mount 85 of the attachment 71, and the standing-up link 74 and the rotation boom 77 rotates by driving the standing-up hydraulic cylinder 73 and rotation hydraulic cylinder 76. In addition, the breaker 11 is located at a easy working state after it rotates to a horizontal and vertical directions by driving the hydraulic motor 80 and 83, a hole 86 with a size which can use the clasped crushing device 12 as shown in FIG. 62 is formed at the floor part of the upper floor.

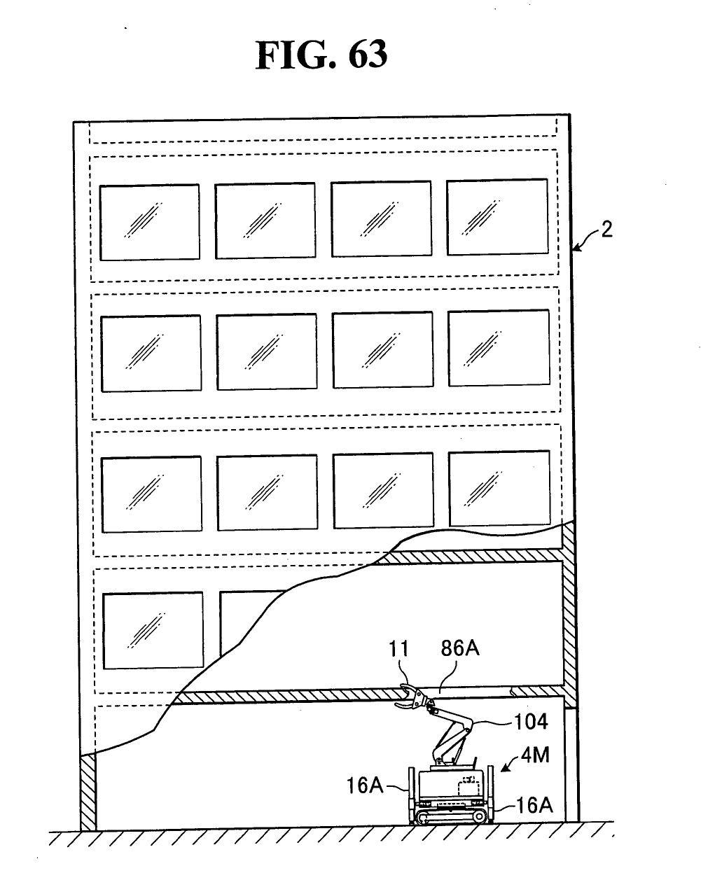

After that, the breaker 11 is removed from the mount 85 of the attachment 71, and the clasped crushing device 12 is attached. Then the clasped crushing device 12 and drive arm 104 are moved, and the hole 86 formed in upper floor is expanded one by one, and a hole 86A of the size which the scrapping machine 4M can pass, as shown in FIG. 63.

In addition, the extensible legs 16A are extended during such working, and the work for forming the hole may be operated.

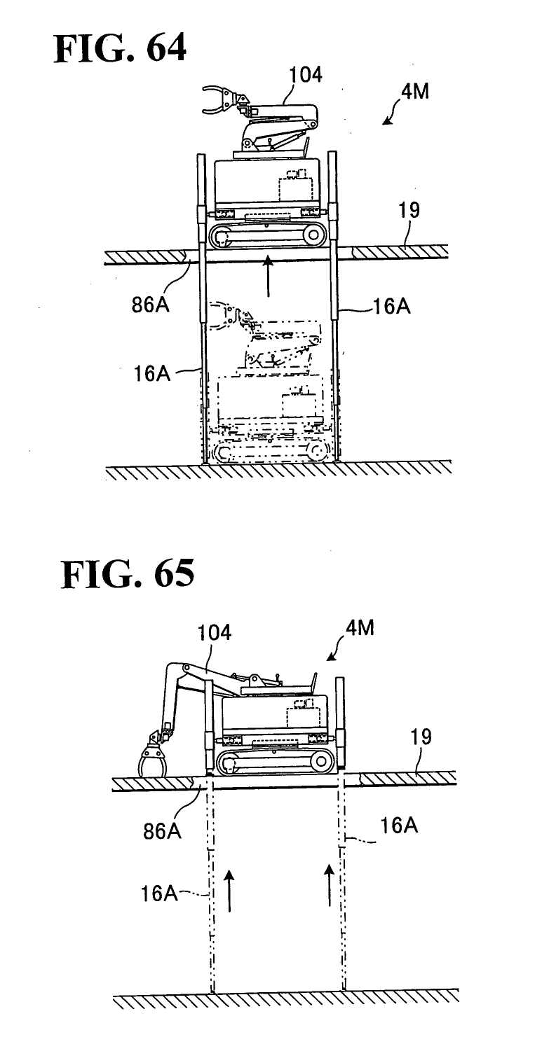

After the hole 86A is formed, the extensible legs 16A are extended, the lower part of he caterpillars 6 passes through the hole 86A and located at the upper portion of the floor part 19 as shown in FIG. 64, and the tip portion of the drive arm 104 is pressed against the floor surface.

Then one of the extensible legs 16A is contracted, and hydraulic cylinders 69 and 69a are operated. The extensible legs 16A is moved to a portion which touches the lower part of the extensible legs 16A to the floor part, and the lower part of the extensible legs 16A is located on the floor part.

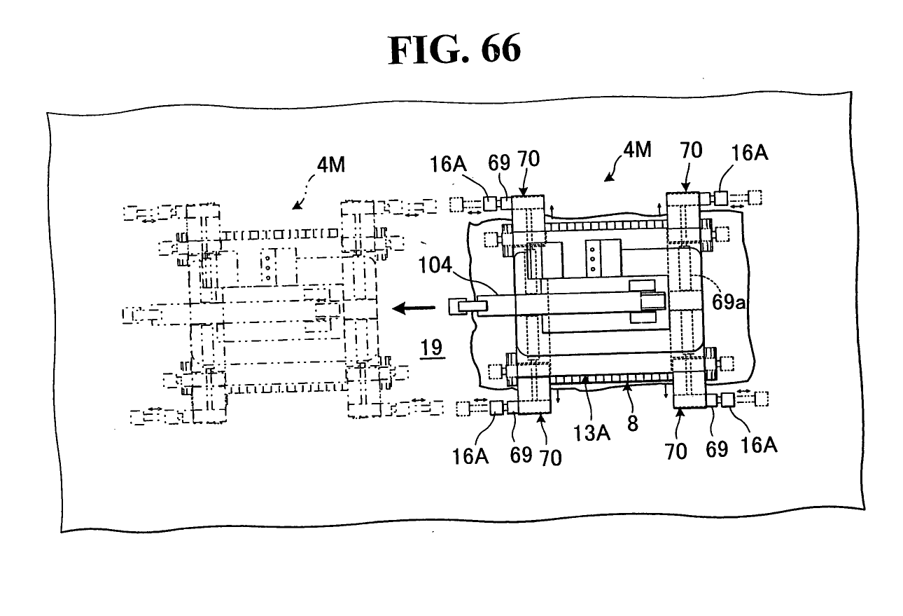

As such work is done one by one, after the extensible legs 16A are supported on the floor part as shown in FIG. 65, any two of the extensible legs 16A are located so as to float on the floor part 19 by the drive arm 104 as shown in FIG. 66. After that, two extensible legs 16A are extended and contracted, and other two extensible legs 16A are extended and contracted. After the scrapping machine 4M is moved to the position which can do a self-run, it runs on the floor part.

Such works are repeated, after the scrapping machine 4M moves to the highest floor, it operates the expansion and contraction of the extensible legs 16A and movement and rotation of the clasped crushing device 12, and the demolition work can be operated.

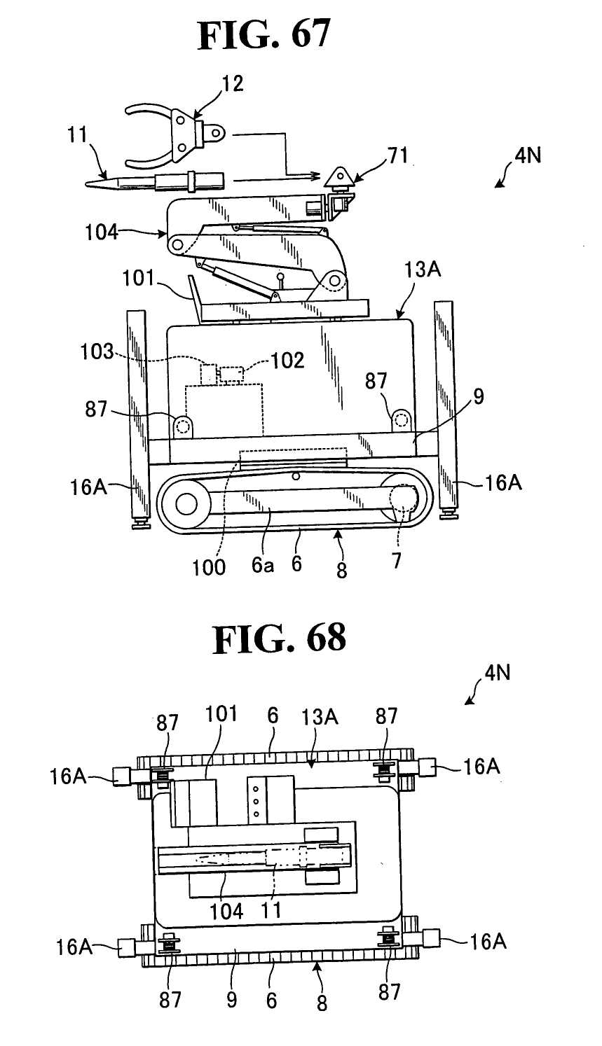

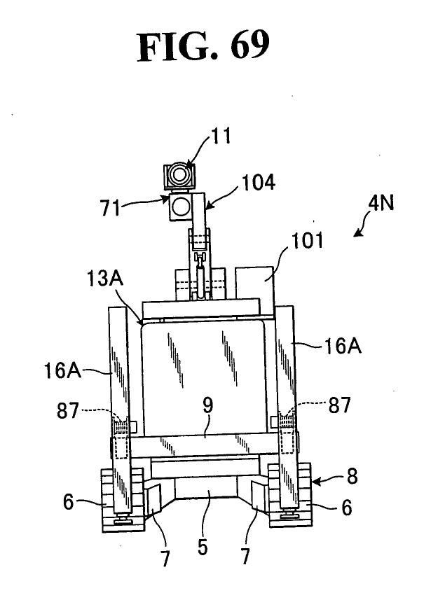

A seventeenth embodiment of the present invention is shown in FIGS. 67-73. It is distinguished from the sixteenth embodiment in that a scrapping machine is formed in the size of a mini backhoe so that it can move upwards using the elevator hole 28; the extensible legs 16A are attached extendably to forward-, backward-, left- and right portions of the base 9 of the body 5, capable of adjusting the height; and winches 87 are attached to forward-, backward-, left- and right portions of the base 9 of the body 5.

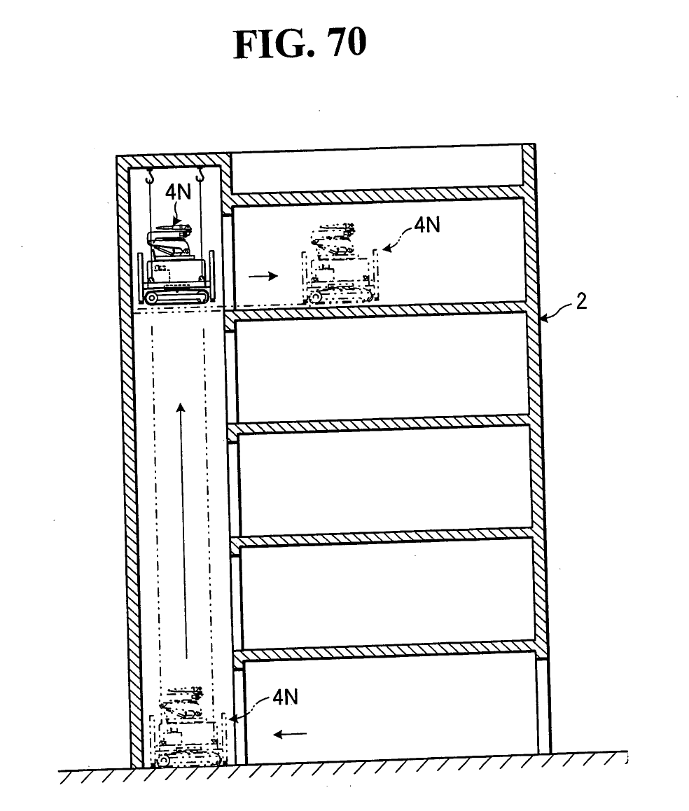

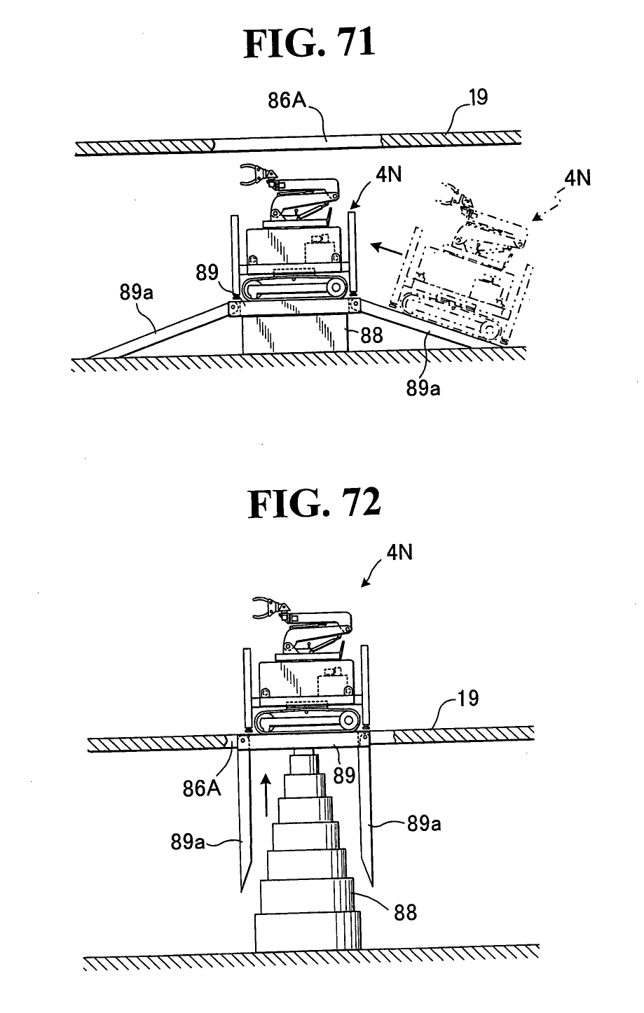

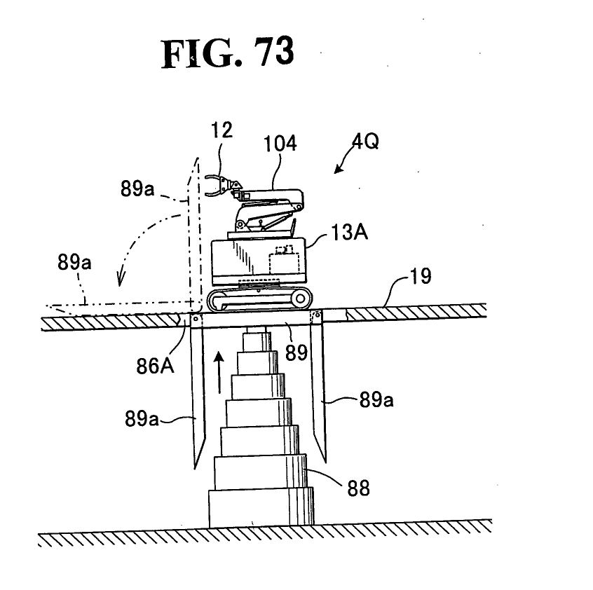

A scrapping machine 4N according to the seventeenth embodiment has similar advantages to that according to the first embodiment, and it can move through the elevator hole 28 as shown in FIG. 70, and it can move upwards by a extensible base 89 having rotatable guide plates 89a. The extensible base 89 can extends on the floor surface of the upper floor by a hydraulic cylinder 88 as shown in FIGS. 71 and 72. In addition, the guide plate 89a may be provided at one side of the extensible base 89. Moreover, in this embodiment, when the extensible base 89 is used to move upward, a scrapping machine 4Q without the movement mechanism to forward-, backward-, left- and right directions and the extensible legs may be used as shown in FIGS. 73.

Moreover, after the scrapping machine 4Q is located on the extensible base 89, the guide plate 89a rotates upward as shown in a dot line, and the extensible base 89 is lifted up. Then, the guide plate 89a is located so as to support at the floor part of the upper floor, and the scrapping machine 4Q may move to the floor part though the hole 86A.

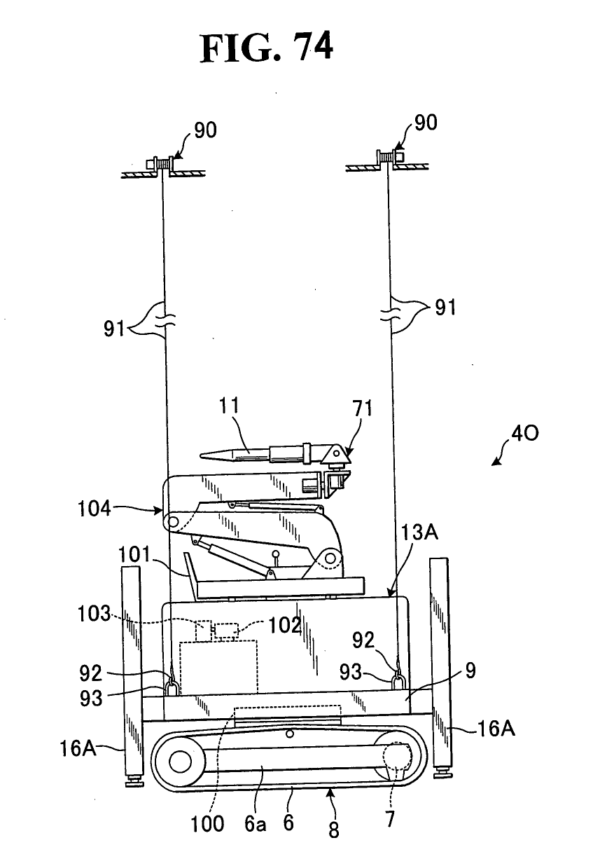

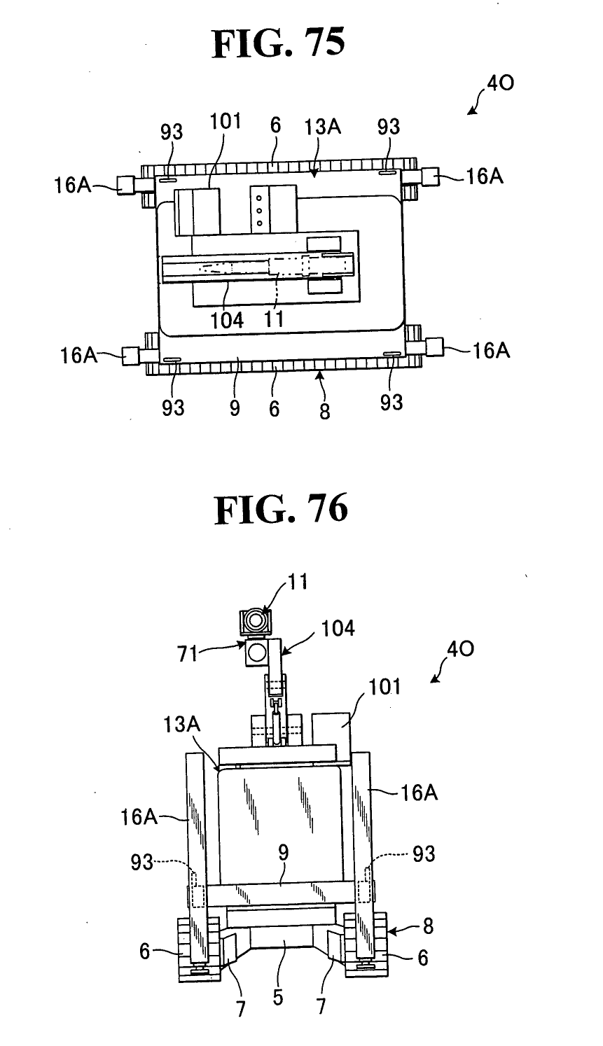

An eighteenth embodiment of the present invention is shown in FIGS. 74-76. It is distinguished from the seventeenth embodiment in that engaging pieces 93 are fixed to the forward-, backward-, left- and right portions of the plate 9 of the body 5, engaging with catching pieces 92 attached to tip portions of wires 91 of winches 91. A scrapping machine 4O according to the eighteenth embodiment has similar advantages to that according to the seventeenth embodiment.

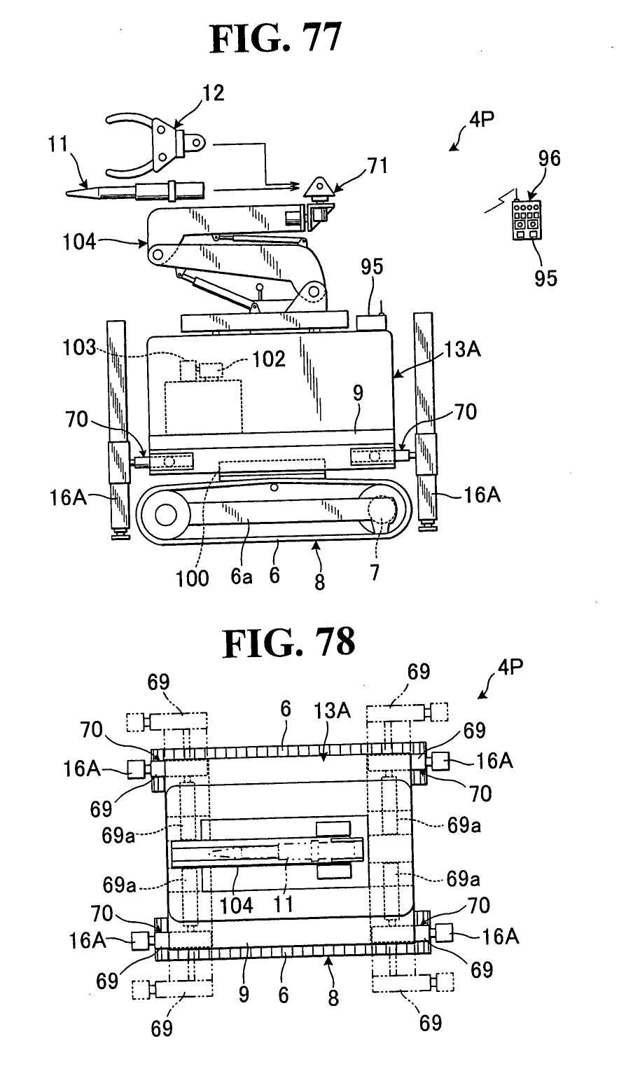

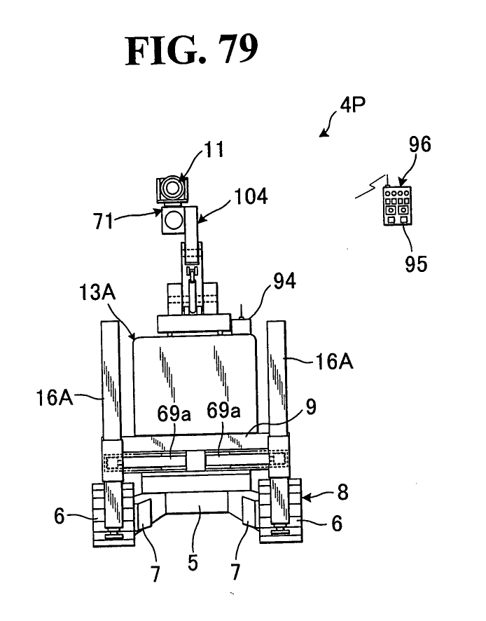

A nineteenth embodiment of the present invention is shown in FIGS. 77-79. It is distinguished from the seventeenth embodiment in that a scrapping machine body 13B having the running device 8, the drive arm 104, movement mechanisms 70, the extensible legs 16A, attachment 71 and a control equipment 94, without the drivers seat; and a remote control equipment 96 using radio control or the remote control. The remote control equipment 96 includes a movement control equipment 95 which can operate the control equipment 94. A scrapping machine 4P can be operated and used by operating the movement control equipment 95 in a safe place.

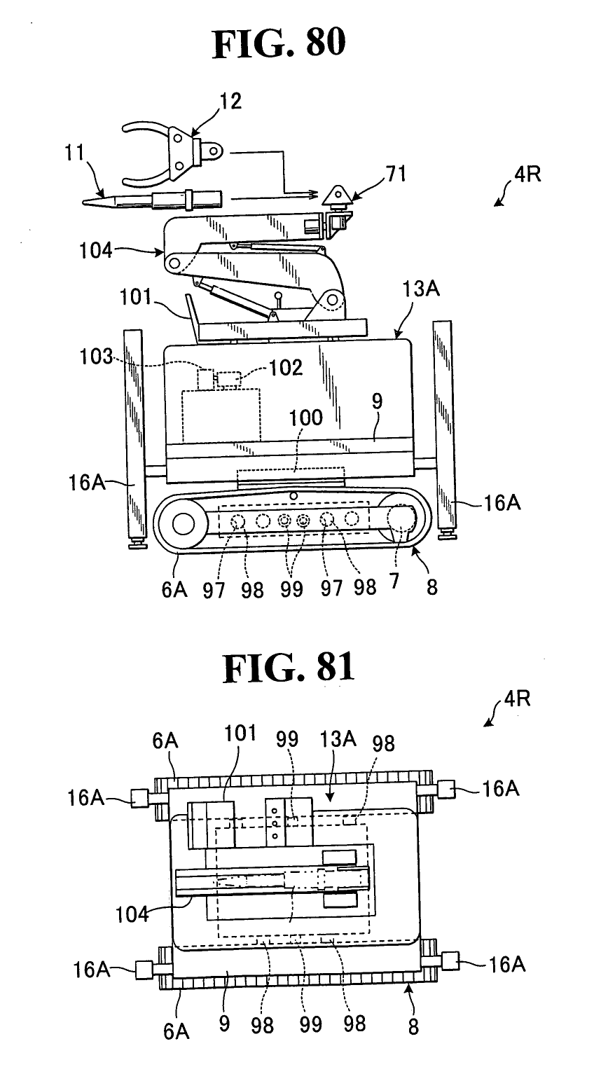

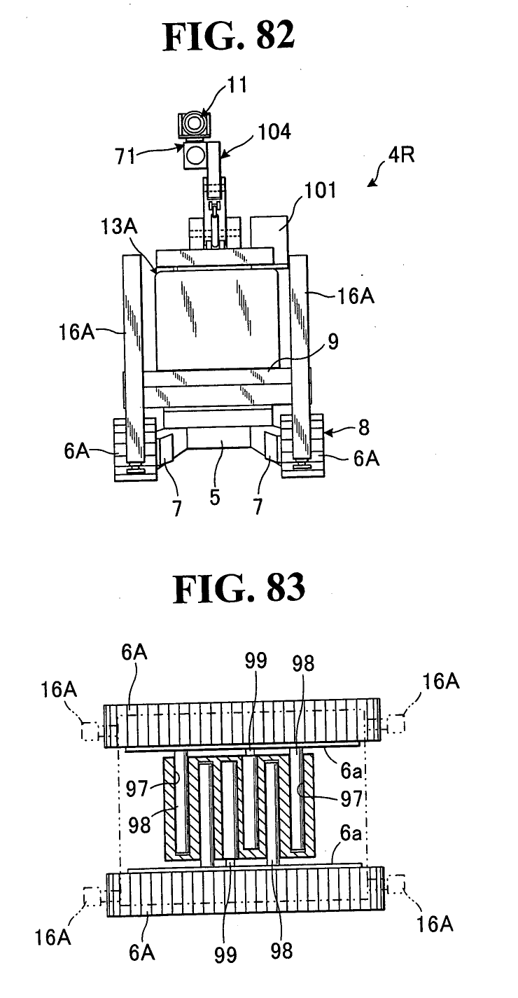

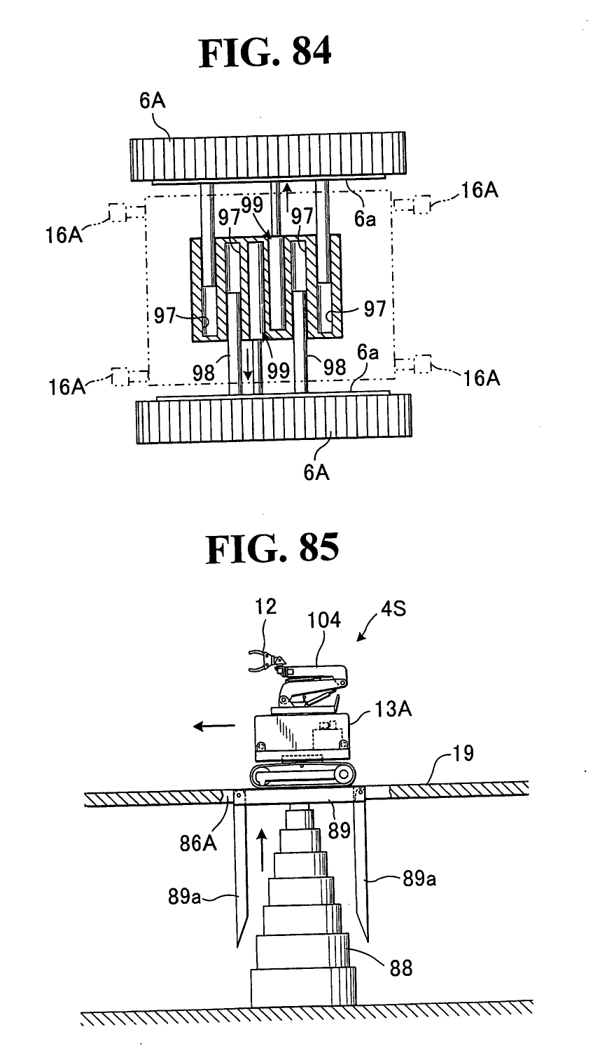

A twentieth embodiment of the present invention is shown in FIGS. 80-85. It is distinguished from the sixteenth embodiment in that the caterpillars 6A includes a support bodies 6a for the caterpillar, having guide pins 98 inserted slidably into guide holes 97 located at both sides of the body 5; and movement devices 99 for caterpillar, providing the hydraulic cylinder and the like which allows the support bodies 6a to slide in the right-and-left direction. In a scrapping machine 4R, the extensible legs 16A are extended, and it passes through the hole 86A and moves to the upper floor. After that, the movement devices 99 are driven, and the caterpillars 6A projects to the right-and-left direction and drives on the floor part.

Therefore, the movement device for allowing the extensible legs 16A to move to forward-, backward-, left- and right directions is not need so that its structure is simple.

Moreover, as shown in FIG. 85, when the upward-moving method with the extensible base 89 is operated, the scrapping machine 4S without the extensible legs has similar advantages to that according to the twentieth embodiment.

In addition, the running device 8 which is used the hydraulic drive device 7 is explained in each of embodiment of the present invention, and the running device may be used in engine, electric motor and the like. Also air cylinder instead of the hydraulic cylinder may be used.

As set forth above, the advantages of the invention are as follows:

(1) A scrapping method of constructions, comprising a steps of moving a scrapping machine of a building, locating the scrapping machine by self-run into the building, the scrapping machine capable of attaching one of a breaker and a clasped crushing device to a tip portion of a drive arm; forming a movement hole which is formed at a floor part of an upper floor by the scrapping machine after the movement process, the scrapping machine capable of passing through the movement hole and moving to the upper floor; moving the scrapping machine to the upper floor via the movement hole; moving the scrapping machine to the highest floor after the hole formation process and the movement process to the upper floor are performed one by one; scrapping at a top part of the building without the floor part located the scrapping machine, the building scrapping so as to place a demolition waste inside the building; discharging the demolition waste that produces at the scrapping process through the movement hole to the lower direction; and performing the demolition work to the lower floor after the scrapping machine moves to the lower floor after scrapping at a top part of the building, and the scrapping process for the top part of the building and discharging process are performed one by one so that it can scrap using the scrapping machine without a drive arm having a same size of the height of the building, and it does not matter of the height of the building

Therefore, it can dissolve efficiently with the scrapping machine in any buildings.

(2) As discussed above (1), it can scrap from inside the building so that the demolition waste is located inside the building.

Therefore, there are no broader installation space and workspace around the building, and it is easy to start work comfortably. Also it does not make trouble to the circumference.

(3) As discussed above (2), since the scrapping is carried out inside of the building, it can prevent efficiently to flow the coarse particulate generated when in scrapping to an outer direction.

(4) As discussed above (1), since it can dissolve from the upper part of the building to the lower part thereof one by one, it can dissolve safely.

(5) The scrapping machine can move upward one by one via the hole. Therefore, it is easy to work with moving to the upper floor.

(6) As discussed above (5), it can use the conventional backhoe that is converted, it can move to the upper floor without miniaturization especially.

1. (canceled)

2. A scrapping method of constructions, comprising a steps of:
moving a scrapping machine to the highest floor through an elevator hole;
scrapping at a top part of the building without the floor part located the scrapping machine, the building scrapping so as to place a demolition waste inside the building;
discharging the demolition waste that produces at the scrapping process through the elevator hole to the lower direction; and
performing the demolition work to the lower floor after the scrapping machine moves to the lower floor after scrapping at a top part of the building, and the scrapping process for the top part of the building and discharging process are performed one by one.

3. A scrapping method of constructions, comprising a steps of:
moving a scrapping machine to a roof portion by one of a winch and crane provided at the roof portion;
scrapping at a top part of the building without the floor part located the scrapping machine, the building scrapping so as to place a demolition waste inside the building; and
performing the demolition work to the lower floor after the scrapping machine moves to the lower floor after scrapping at a top part of the building, and the scrapping process for the top part of the building and discharging process are performed one by one.

4. A scrapping method of constructions, comprising a steps of:
moving a scrapping machine of a building, locating the scrapping machine by self-run into the building, the scrapping machine capable of attaching one of a breaker and a clasped crushing device to a tip portion of a drive arm;
forming a first movement hole formed to move the scrapping machine to the upper floor after the movement process is performed;
firstly moving the scrapping machine to the upper floor through the first movement hole;
forming a second movement hole to move the scrapping machine to the upper floor, the second movement hole forming on an upper floor portion which is located at a different place from the first movement hole;
secondary moving the scrapping machine through the second movement hole;
moving the scrapping machine to the highest floor of the building after the forming process for the first movement hole, the first movement process, the forming process for the second movement hole and the second movement process are performed one by one;
scrapping an upper portion of the building so that the demolition waste is located inside the building and is discharged to the lower floor, and scrapping the floor part located the scrapping on the floor part;
performing the demolition work to the lower floor, discharging the demolition waste to the lower floor through the movement hole, scrapping a top of the building so that the demolition waste is located inside the building and discharging the demolition waste to the lower floor through the movement hole, and scrapping the floor part by the scrapping machine located on the floor or the demolition waste discharged; and
scrapping step for performing the demolition work to the lower floor one by one.

5. A scrapping machine comprising:
a body;
a running device attached to the body, capable of running the body using an oil pressure and the like;
a scrapping machine body attached to the body capable of rotating in a horizontal direction, having a drive arm and a tip portion of the drive arm attaching one of a breaker and a clasped crushing device;
extensible legs attached to the body with at least four hydraulic cylinders enabling one of the body and the scrapping machine body to move up to an upper floor of the building, attaching to forward-, backward-, right-and left portions of the body and capable of moving slidably to one of forward-and-backward direction and right-and-left directions or forward-, backward-, right- and left directions by the hydraulic cylinders; and
four winches capable of lifting the body up to the highest floor, four wires extending from the winches and each having a free end carrying a hook, the hooks being attached to respective forward, backward, right and left positions of the body.

6. (canceled)

7. A scrapping machine comprising:
a body;
a running device attached to both sides of the body so as to project to the right and left directions, capable of running the body using an oil pressure and the like provided by a movement device for caterpillars having a hydraulic cylinders and the like;
a scrapping machine body attached to an upper portion of the body capable of rotating in a horizontal direction, having a drive arm and rotation boom;
a crushing machine including a breaker and a clasped crushing device, attaching rotatably to a tip portion of the rotation boom of the scrapping machine body;
support members for right and left extensible legs, attaching projectably to right and left sides of the body to the right and left directions, the support members attaching the upper portion rather than the upper end of the caterpillars; and
extensible legs provided to the front and back portions of the support members, having hydraulic cylinders capable of locating outer portions rather than the front and back portions of the caterpillars, a lower portion thereof located above the lower end portion of the caterpillars in a storing manner, and allowing the lower portion of the caterpillars to locate the upper portion of the floor part of the upper floor in an extending manner.

8. A scrapping machine according to claim 7, wherein the support members is formed in the shape of a bar, and the extensible legs is stored rotatably above the support members when in not use, stands with rotating by the hydraulic cylinders when in use and allows the lower portion of the caterpillars to locate the upper portion of the floor part of the upper floor in an extending manner.

9. A scrapping machine according to claim 7, wherein the support members are attached at the forward-, backward-, left- and right parts fixed to a tip portion of the body, positioning above the upper end portion of the caterpillars and outside the front and back ends of the caterpillars; and the extensible legs provided at a tip portion of the support members, having hydraulic cylinders capable of locating outer portions rather than the front and back portions of the caterpillars, a lower portion thereof located above the lower end portion of the caterpillars in a storing manner, and allowing the lower portion of the caterpillars to locate the upper portion of the floor part of the upper floor in an extending manner.

10. A scrapping machine comprising:
a body;
a running device attached to both sides of the body so as to project to the right and left directions, capable of running the body using an oil pressure and the like provided by a movement device for caterpillars having a hydraulic cylinders and the like;
a scrapping machine body attached to an upper portion of the body capable of rotating in a horizontal direction, having a drive arm and rotation boom;
a crushing machine including a breaker and a clasped crushing device, attaching rotatably to a tip portion of the rotation boom of the scrapping machine body;
extensible legs provided fixedly at forward-, backward-, left- and right portions of the body, positioned an outer portion rather than the front and back portions of the caterpillars, having hydraulic cylinders capable of locating outer portions rather than the front and back portions of the caterpillars, a lower portion thereof located above the lower end portion of the caterpillars in a storing manner, and allowing the lower portion of the caterpillars to locate the upper portion of the floor part of the upper floor in an extending manner; and
extensible leg pieces attached projectably and rotatably at lower portions of the extensible legs so as to project to an outer direction when in use.

11. A scrapping machine comprising:
a body;
a running device attached to the body, capable of running the body using an oil pressure and the like;
a scrapping machine body attached to the body, capable of rotating in a horizontal direction, having a drive arm;
extensible legs attached to forward-, backward-, right-and left portions of the body, having hydraulic cylinders and the like, capable of moving the body up to an upper floor of the building;
an attachment for a crushing machine attached to the tip portion of the drive arm, having the crushing machine including one of a breaker and a clasped crushing device attached detachably at a tip portion thereof which drives rotatably; and
a movement mechanism to forward, backward, right and left portions attaching the extensible legs to forward, backward, right and left portions of the body.

12-15. (canceled)

16. A scrapping machine comprising:
a body;
a running device attached to the body, capable of running the body using an oil pressure and the like;
a scrapping machine body attached to the body, capable of rotating in a horizontal direction, having a drive arm;
extensible legs attached to forward-, backward-, right-and left portions of the body, having hydraulic cylinders and the like, capable of moving the body up to an upper floor of the building; and
an attachment for a crushing machine attached to the tip portion of the drive arm, having the crushing machine including one of a breaker and a clasped crushing device attached detachably at a tip portion thereof which drives rotatably;
and engaging pieces fixed to forward, backward, left and right portions of the body engaging with catching pieces attached to respective four winches and tip portions.

17. A scrapping machine comprising:
a body;
a running device attached to both sides of the body so as to project to the right and left directions, capable of running the body using an oil pressure, the running device comprising caterpillar tracks and a hydraulic drive;
a scrapping machine body attached to the body, capable of rotating in a horizontal direction, having a drive arm;
extensible legs attached to forward-, backward-, right-and left portions of the body, having hydraulic cylinders and the like, capable of moving the body up to an upper floor of the building; and
an attachment for a crushing machine attached to the tip portion of the drive arm, having the crushing machine including one of a breaker and a clasped crushing device attached detachably at a tip portion thereof which drives rotatably.
